(19) United States
(12) Patent Application Publication
(10) Pub. No.: US 2018/0048011 A1
(43) Pub. Date: Feb. 15, 2018

(54) HIGH pH ORGANIC FLOW BATTERY

(71) Applicant: President and Fellows of Harvard College, Cambridge, MA (US)

(72) Inventors: Michael J. AZIZ, Cambridge, MA (US); Roy G. GORDON, Cambridge, MA (US); Kaixiang LIN, Cambridge, MA (US); Michael MARSHAK, Cambridge, MA (US); Qing CHEN, Cambridge, MA (US); Michael R. GERHARDT, Cambridge, MA (US)

(21) Appl. No.: 15/556,140

(22) PCT Filed: Mar. 7, 2016
(86) PCT No.: PCT/US16/21253

§ 371 Date: Sep. 6, 2017

Related U.S. Application Data
(60) Provisional application No. 62/129,281, filed on Mar. 6, 2015.
(60) Provisional application No. 62/138,129, filed on Mar. 25, 2015.
(60) Provisional application No. 62/216,119, filed on Sep. 9, 2015.
(60) Provisional application No. 62/259,502, filed on Nov. 24, 2015.

(51) Int. Cl. H01M 8/18; H01M 8/0289

(52) U.S. Cl. CPC H01M 8/188; H01M 8/0289

(57) ABSTRACT

Provided herein are redox flow (e.g., rechargeable) batteries having a first aqueous electrolyte including a first type of redox active material (e.g., a quinone or alloxazine) and a second aqueous electrolyte including a second type of redox active material. The invention also features a method for storing electrical energy involving charging a battery including first and second electrodes and a method for providing electrical energy involving discharging a battery including the same.

### STATEMENT REGARDING FEDERALLY SPONSORED RESEARCH

This invention was made with government support under grant number DE-AR0000348 from the Advanced Research Projects Agency-Energy-U.S. Department of Energy and under grant number 1509041 from the National Science Foundation. The government has certain rights to the invention.

### BACKGROUND OF THE INVENTION

Intermittent renewable electrical power sources such as wind and photovoltaics (PV) cannot replace a significant fraction of our current fossil fuel-based electrical generation unless the intermittency problem is solved. Fluctuations in renewable source power are generally backed up by natural gas fired “peaker” plants. Inexpensive, reliable energy storage at or near the generation site could render the renewable source dispatchable (e.g. demand-following). It could also permit full utilization of the transmission capacity of power lines from the generation site, permitting supply capacity expansion while deferring the need for transmission capacity expansion. The advantages of flow batteries are giving them increased attention for grid-scale electrical storage (T. Nguyen and R. F. Savinell, Electrochem. Soc. Int. 19, 54 (2010)): because all of the reactants and products are stored in tanks outside the electrochemical conversion device, the device itself may be optimized for the required power while the required energy is independently determined by the mass of reactant and the size of storage tanks. This can drive down the storage cost per kWh, which is the single most challenging requirement for grid-scale storage. In contrast, in solid electrode batteries the energy/power ratio (i.e., the peak-power discharge time) does not scale and is inadequate for rendering intermittent renewable power sources dispatchable. Most solid-electrode batteries have peak-power discharge times <1 hr., whereas rendering PV and wind dispatchable requires many hours to days (J. S. Rugolo and M. J. Aziz, Energy & Env. Sci. 5, 7151 (2012)).

By its nature the design of the zinc-bromine hybrid flow battery-involving Zn plating within the electrochemical conversion device-does not permit flow battery-like energy scaling; it also presents a dendrite-shorting risk (T. Nguyen and R. F. Savinell, Electrochem. Soc. Int. 19, 54 (2010)). Arguably the most developed flow battery technologies are vanadium redox flow batteries (VRBs) and sodium-sulfur batteries (NaSBs). Costs per kW are comparable, whereas VRBs are considerably more costly on a cost per kWh basis, in part due to the high price of vanadium, which sets a floor on the ultimate cost per kWh of a VRB (B. Dunn, H. Kamath, and J. M. Tarascon, Science 334, 928 (2011)). The vanadium itself costs around $160/kWh based on recent costs for V205 (“Mineral Commodity Summaries,” (U.S. Geological Survey, Reston, Va., 2012), p. 178). VRBs do benefit from a longer cycle life, with the ability to be cycled in excess of 10,000 times, whereas NaSBs are typically limited to about 4,500 cycles (B. Dunn, H. Kamath, and J. M. Tarascon, Science 334, 928 (2011)). For VRBs, costs per kW are likely to move lower, as recent improvements in VRB cell design have led to significantly higher power densities and current densities, with values of 1.4 W/cm² and 1.6 A/cm², respectively (M. L. Perry, R. M. Darling, and R. Zaffou, “High Power Density Redox Flow Battery Cells”, ECS Trans. 53, 7, 2013), but these don't help lower the ultimate floor on the cost per kWh. These values, to our knowledge, represent the best performance achieved in VRBs reported to date in the literature. NaSBs have to operate above 300° C. to keep the reactants molten, which sets a floor on their operating costs. Over 100 MW of NaSBs have been installed on the grid in Japan, but this is due to government fiat rather than market forces. VRBs are the subject of aggressive development, whereas NaSBs represent a reasonably static target. There is also recent work on the regenerative electrolysis of hydrohalic acid to dihalogen and dihydrogen (V. Livshits, A. Ulus, and E. Peled, Electrochem. Comm. 8, 1358 (2006); T. V. Nguyen, H. Kreutzer, E. McFarland, N. Singh, H. Metiu, A. Ivanovskaya, and R.-F. Liu, ECS Meeting Abstracts 1201, 367 (2012); K. T. Cho, P. Albertus, V. Battaglia, A. Kojic, V. Srinivasan, and A. Z. Weber, “Optimization and Analysis of High-Power Hydrogen/Bromine-Flow Batteries for Grid-Scale Energy Storage”, Energy Technology 1, 596 (2013); B. T. Huskinson, J. S. Rugolo, S. K. Mondal, and M. J. Aziz, arXiv:1206.2883 [cond-mat.mtrl-sci]; Energy & Environmental Science 5, 8690 (2012)), where the halogen is chlorine or bromine. These systems, however, share the disadvantage of storing highly flammable and explosive hydrogen gas. These systems have the potential for lower storage cost per kWh than VRBs due to the lower cost of the chemical reactants. However, the use of halogens and strong acids in this storage system presents hazards of toxicity and corrosion.

### SUMMARY OF THE INVENTION

The invention provides for electrochemical storage of energy based on redox-active compounds dissolved or suspended in an aqueous solution, e.g., a basic aqueous solution. Organic compounds such as quinones and alloxazines, including related isomers such as isoalloxazines and polymers, are particularly suitable as the redox-active materials. Flow batteries based on these materials can store large amounts of energy. Because of the non-hazardous nature of these compounds, this method of storage is safe for use in the large-scale electrical grid or for smaller-scale use in buildings. Flow batteries have scaling advantages over solid electrode batteries for large scale energy storage. Batteries based on quinones and alloxazines can have high current density, high efficiency, and long lifetime in a flow battery. High current density drives down power-related costs. The other advantages this particular technology has over other flow batteries include inexpensive chemicals, energy storage in the form of safer liquids, an inexpensive separator, little or no precious metals usage in the electrodes, and other components made of plastic or inexpensive metals with coatings proven to afford corrosion protection. Variations of quinone- and alloxazine-based cells are described.

In one aspect, the invention features a redox flow battery including a first aqueous electrolyte including a first type of redox active material and a second aqueous electrolyte including a second type of redox active material, wherein the first type of redox active material comprises an organic compound (e.g., a quinone or alloxazine).

In some embodiments, the battery further comprises a first electrode in contact with the first aqueous electrolyte and a second electrode in contact with the second aqueous electrolyte. In its discharged state, the battery includes an organic compound (e.g., a quinone or an alloxazine) dissolved or suspended in aqueous solution (e.g., a solution of pH greater than 7) in contact with the first electrode and a redox active species in contact with the second electrode, wherein during charge an alloxazine is reduced to a hydroalloxazine or ion thereof, or a quinone is reduced to a hydroquinone or ion thereof, and the redox active species is oxidized. Examples of redox active species include ferricyanide ion, ferrocyanide ion, or a mixture thereof, aluminum(III) biscitrate monocatecholate, bromine or bromide, and iodine or iodide, e.g., when the organic compound is a quinone. In other embodiments, the redox active species is dissolved or suspended in aqueous solution.

In some embodiments, the battery further comprises a separator between the first aqueous electrolyte and the second aqueous electrolyte. The separator may be an ion conducting barrier, such as a porous physical barrier or a size exclusion barrier. The separator may comprise a porous material, a cation exchange membrane, or an ion-conducting glass.

In some embodiments, the battery further comprises reservoirs for the first aqueous electrolyte and the second aqueous electrolyte and a mechanisms to circulate the electrolytes.

In some embodiments, the first aqueous electrolyte has a pH between about 7 and about 10, or between about 10 and about 12, or between about 12 and about 14. In other embodiments, the pH of the first aqueous electrolyte is at least 7, at least 8, at least 9 at least 10, at least 11, at least 12, at least 13, or at least 14.

In some embodiments, the first type of redox active material is present in the first aqueous electrolyte in a concentration of at least about 0.5 M, at least about 1 M, or at least about 2 M. In some embodiments, the first type of redox active material is present in the first aqueous electrolyte in a concentration of between about 0.5 and about 2 M, or between about 2 M and about 4 M.

Organic compounds usable in the invention include those of formula (I):

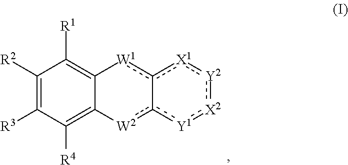

wherein

i) W¹ and W² are -C═O, and Y¹ is -C(R⁵)-, X² is -C(R⁶)-, Y² is -C(R⁷)-, and X¹ is -C(R⁸)-;

ii) X¹ and X² are -C═O, W¹ and W² are -N-, Y¹ is -N(R⁹)-, and Y² is -N(R¹⁰)-; or

iii) X¹ and X² are -C═O, W² is -N(R⁹)-, Y² is -N(R¹⁰)-, and W¹ and Y¹ are -N-,

wherein bonds shown with dashed lines are single or double bonds, and

wherein each of R⁹ and R¹⁰, if present, is independently H; halo; optionally substituted C₁₋₆ alkyl (e.g., unsubstituted C₁₋₆ alkyl); optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; -C(═O)Rₐ; and -C(═O)ORₐ; and each of R¹, R², R³, R⁴, R⁵, R⁶, R⁷ and R⁸, if present, is independently H; halo; optionally substituted C₁₋₆ alkyl; oxo; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; -CN; -NO₂; -ORₐ (e.g., hydroxyl or C₁₋₆ alkoxy); -N(Rₐ)₂ (e.g., amino); -C(═O)Rₐ; -C(═O)ORₐ (e.g., carboxyl); -S(═O)2Rₐ; -S(═O)20Rₐ (e.g., SO₃H); -P(═O)Rₐ₂; and -P(═O)(ORₐ)2 (e.g., phosphonyl or phosphoryl); or any two adjacent groups selected from R¹, R², 1:1³, and R⁴ are joined to form an optionally substituted 3-6 membered ring, or an ion thereof;

wherein each Rₐ is independently H; C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group.

In certain embodiments, R¹, R², R³, R⁴, R⁵, R⁶, R⁷, R⁸, R⁹ and R¹⁰ are not halo, and R¹, R², R³, R⁴, R⁵, R⁶, R⁷, and R⁸ are not -CN. In particular embodiments, each of R¹, R², R³, R⁴, R⁵, R⁶, R⁷ and R⁸, if present, is independently selected from H, hydroxyl, optionally substituted C₁₋₄ alkyl, carboxyl, and SO₃H, such as each of R¹, R², R³, R⁴, R⁵, R⁶, R⁷ and R⁸, if present, being independently selected from H, hydroxyl, optionally substituted C₁₋₄ alkyl (e.g. methyl), and oxo, or an ion thereof.

In some embodiments, R⁹ and R¹⁰ are independently, H, optionally substituted C₁₋₄ alkyl, or carboxyl, e.g., H or methyl.

In some embodiments, W¹ and W² are -0═0, and Y¹ is -C(R⁵)-, X² is -C(R⁶)-, Y² is -C(R⁷)-, and X¹ is -C(R⁸)-. In other embodiments, X¹ and X² are -0═0, W¹ and W² are -N-, Y¹ is -N(R⁹)-, and Y² is -N(R¹⁰)-. In further embodiments, X¹ and X² are -0═0, W² is -N(R⁹)-, Y² is -N(R¹⁰)-, and W¹ and

Y¹ are -N-.

In some embodiments, the compound is substituted with at least one hydroxyl group. Fused rings formed by adjacent groups of R¹, R², R³, and R⁴ may be carbocyclyl, aryl, heteroaryl, or heterocyclyl, as defined herein. In some embodiments, the compound is a quinone (e.g., an anthraquinone) of formula (II):

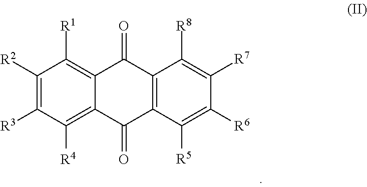

In particular embodiments of formula (II), each of R1, R2_{,} R3_{,} R4, _{R5,} ^{R6,} R⁷ and R⁸ is independently selected from H, optionally substituted C₁₋₆ alkyl, halo, hydroxyl, optionally substituted C₁₋₆ alkoxy, SO₃H, amino, nitro, carboxyl, phosphoryl, phosphonyl, and oxo, or an ion thereof. In particular embodiments, each of R1, R2_{,} R3_{,} R4, _{R5,} ^{R6,} R⁷, and R⁸ is independently selected H, optionally substituted C₁₋₆ alkyl, hydroxyl, optionally substituted C₁₋₆ alkoxy, SO₃H, amino, nitro, carboxyl, phosphoryl, phosphonyl, and oxo, or an ion thereof, e.g., H, hydroxyl, optionally substituted C₁₋₄ alkyl, carboxyl, and SO₃H, such as each of R1, R2_{,} R3_{,} R4, _{R5,} ^{R6,} R⁷ and R⁸ being independently selected from H, hydroxyl, optionally substituted C₁₋₄ alkyl (e.g. methyl), and oxo, e.g., selected from H, hydroxyl, and oxo. In other embodiments, the quinone, e.g., an anthraquinone, such as a 9,10-anthraquinone, is substituted with at least one hydroxyl group and optionally further substituted with a C¹⁻⁴ alkyl, such as methyl. Exemplary quinones include 2,6-dihydroxy-9,10-anthraquinone (2,6-DHAQ), 1 ,5-dimethyl-2,6-dihydroxy-9,1 0-anthraquinone, 2,3,6,7-tetrahydroxy-9,1 0-anthraquinone, 1,3,5,7-tetrahydroxy-2,4,6,8-tetramethyl-9,10-anthraquinone, and 2,7-dihydroxy-1,8-dimethyl-9,10-anthraquinone. Other quinones are shown in Table 1 below. For the purposes of this invention, the term “quinone” includes a compound having one or more conjugated, C₃₋₁₀ carbocyclic, fused rings, substituted, in oxidized form, with two or more oxo groups, which are in conjugation with the one or more conjugated rings. Preferably, the number of rings is from one to ten, e.g., one, two, or three, and each ring has 6 members. For example, the anthraquinone shown in formula (II) has three 6-membered rings. A hydroquinone is a reduced form of a quinone.

In some embodiments, the compound is an alloxazine of formula (III):

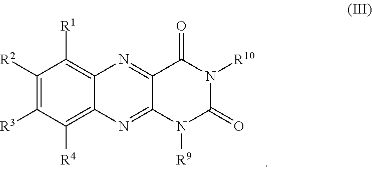

In some embodiments of formula (III), each of R⁹ and R¹⁰ is independently H; optionally substituted C₁₋₆ alkyl (e.g., unsubstituted C₁₋₆ alkyl); optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; -C(═O)Rₐ; and -C(═O)ORₐ; and each of R¹, R², R³, and R⁴ is independently H; C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; -NO₂; -ORₐ; -N(Rₐ)₂; -C(═O)Rₐ; -C(═O)ORₐ; -S(═O)2Rₐ; -S(═O)2ORₐ; -P(═O)Rₐ₂; and -P(═O)(ORₐ)₂; or any two adjacent groups selected from R¹, R², R³, and R⁴ are joined to form an optionally substituted 3-6 membered ring, or an ion thereof; wherein each Rₐ is independently H; C₁₋₆ alkyl; optionally substituted C₃₋₁₀ carbocyclyl;

optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group. In some embodiments, each of R⁹ and R¹⁰ is independently H, optionally substituted C₁₋₆ alkyl, or -C(═O)ORₐ; and each of R¹, R², R³, and R⁴ is independently H, optionally substituted C₁₋₆ alkyl, -NO2, -ORₐ, -N(Rₐ)2, -C(═O)ORₐ, -S(═O)20Rₐ, -P(═O)R_{a 2} or -P(═O)(ORₐ)₂; wherein each Rₐ is independently H or optionally substituted C₁₋₆ alkyl.

In some embodiments, none of, any two of, any three of, any four of, any five of, or any six of R¹, R², R³, R⁴, R⁹, and R¹⁰ are H.

For the purposes of the invention, the term “alloxazine” includes, unless otherwise noted, isomeric forms of this structure, such as the isoalloxazine shown in formula (IV):

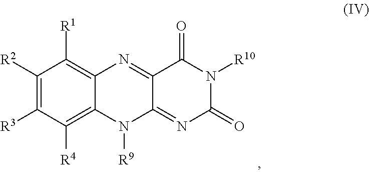

wherein each of R¹, R², R³, R⁴, R⁹, and R¹⁹ are as described above. Formula (IV) differs from formula (III) in that a substituent is placed on position 10, rather than on position 1, in the conventional numbering scheme commonly used for such ring systems in organic chemistry. Because of this isomeric shift, one of the double bonds in the structure is shifted to an adjacent bond. This formula (IV) is also commonly called a flavin. The term “alloxazine” further encompasses polymers, e.g., dimers and trimers, of formula (V) or (VI):

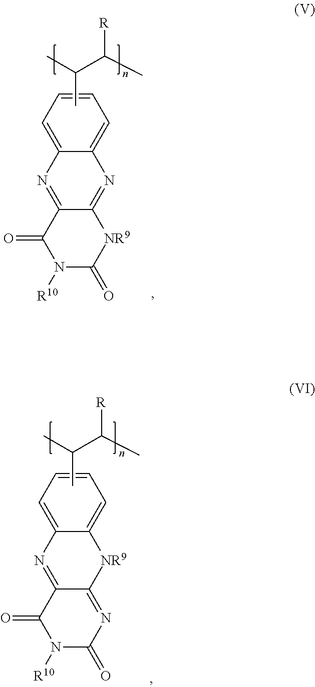

wherein n is an integer from 2 to 40; R⁹ and R¹⁰, are as described above; and wherein R is a substituent that increases the aqueous solubility of the polymer, e.g., -OH, -COOH, -S03H, -N(Rₐ)2, and -P(═O)(ORₐ)2, where at least one Rₐ is H and other groups known in the art. In preferred embodiments, one or both of R⁹ and R¹⁹ are H.

In some embodiments, the compound is riboflavin 5′ phosphate, having the formula

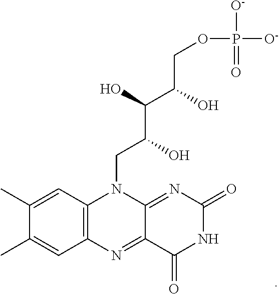 [SMILES: Cc1cc2nc3c(=O)[nH]c(=O)nc-3n(C[C@@H](O)[C@@H](O)[C@@H](O)COP(=O)([O-])[O-])c2cc1C]

In some embodiments, the compound is an alloxazine comprising a mixture of the isomeric structures alloxazine 7-carboxylic acid and alloxazine 8-carboxylic acid:

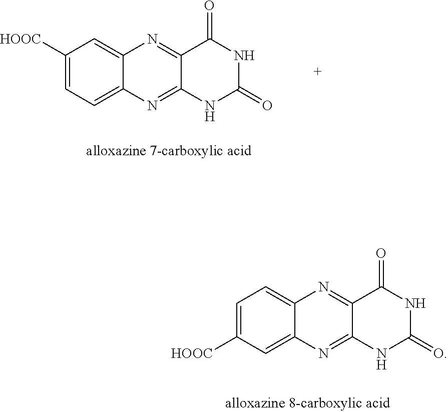 [SMILES: O=C(O)c1ccc2nc3[nH]c(=O)[nH]c(=O)c3nc2c1 ; O=C(O)c1ccc2nc3c(=O)[nH]c(=O)[nH]c3nc2c1]

In some embodiments, the compound is an alloxazine comprising a mixture of the isomeric structures 7-hydroxyalloxazine and 8-hydroxyalloxazine:

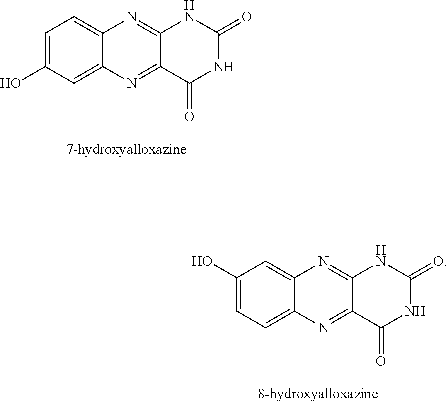 [SMILES: O=c1[nH]c(=O)c2nc3cc(O)ccc3nc2[nH]1 ; O=c1[nH]c(=O)c2nc3ccc(O)cc3nc2[nH]1]

In some embodiments, the compound of formula (I) comprises 7,8-dihydroxyalloxazine:

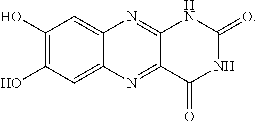 [SMILES: O=c1[nH]c(=O)c2nc3cc(O)c(O)cc3nc2[nH]1]

It will be understood that, when oxo substituents are present on the ring, that the double bonds of the fused rings will be moved or eliminated to allow for conjugation of the rings.

In a related aspect, the invention provides a method for storing electrical energy comprising applying a voltage across a first electrode in contact with the first aqueous electrolyte and a second electrode in contact with the second aqueous electrolyte and charging a battery as described herein.

The invention further provides a method for providing electrical energy by connecting a load to a first electrode in contact with the first aqueous electrolyte and a second electrode in contact with the second aqueous electrolyte and allowing a battery as described herein to discharge.

The use of organic compounds (e.g., quinones or alloxazines) offers several advantages over other flow battery technologies including non-toxicity, scalability, fast kinetics, high stability, high solubility, and voltage tunability. These features lower the capital cost of storage chemicals per kWh, which sets a floor on the ultimate system cost per kWh at any scale. Optimization of engineering and operating parameters such as the flow field geometry, electrode design, membrane separator, and temperature should lead to significant performance improvements in the future.

By “alkyl” is meant straight chain or branched saturated groups from 1 to 6 carbons. Alkyl groups are exemplified by methyl, ethyl, n- and iso-propyl, n-, sec-, iso- and tert-butyl, neopentyl, and the like, and may be optionally substituted with one or more, substituents. By “alkoxy” is meant a group of formula -OR, wherein R is an alkyl group, as defined herein.

By “alkyl thio” is meant -S-R, where R is an alkyl group, as defined herein. By “alkyl ester” is meant -COOR, where R is an alkyl group, as defined herein. By “aryl” is meant an aromatic cyclic group in which the ring atoms are all carbon. Exemplary aryl groups include phenyl, naphthyl, and anthracenyl. Aryl groups may be optionally substituted with one or more substituents.

By “carbocyclyl” is meant a non-aromatic cyclic group in which the ring atoms are all carbon. Exemplary carbocyclyl groups include cyclopropyl, cyclobutyl, cyclopentyl, cyclohexyl, cycloheptyl, and cyclooctyl. Carbocyclyl groups may be optionally substituted with one or more substituents.

By “halo” is meant, fluoro, chloro, bromo, or iodo. By “hydroxyl” is meant -OH. An exemplary ion of hydroxyl is -0⁻.

By “amino” is meant -NH2. An exemplary ion of amino is -NH3+. By “nitro” is meant -NO2. By “carboxyl” is meant -COON. An exemplary ion of carboxyl is -COO⁻. By “phosphoryl” is meant -P03H2. Exemplary ions of phosphoryl are -POSH⁻ and -P03²⁻. By “phosphonyl” is meant -P03R2, wherein each R is H or alkyl, provided at least one R is alkyl, as defined herein. An exemplary ion of phosphoryl is -P03R⁻.

By “oxo” is meant ═0. By “sulfonyl” is meant -SO₃H. An exemplary ion of sulfonyl is -S03. By “thiol” is meant -SH. By “heteroaryl” is meant an aromatic cyclic group in which the ring atoms include at least one carbon and at least one O, N, or S atom, provided that at least three ring atoms are present. Exemplary heteroaryl groups include oxazolyl, isoxazolyl, tetrazolyl, pyridyl, thienyl, furyl, pyrrolyl, imidazolyl, pyrimidinyl, thiazolyl, indolyl, quinolinyl, isoquinolinyl, benzofuryl, benzothienyl, pyrazolyl, pyrazinyl, pyridazinyl, isothiazolyl, benzimidazolyl, benzothiazolyl, benzoxazolyl, oxadiazolyl, thiadiazolyl, and triazolyl. Heteroaryl groups may be optionally substituted with one or more substituents.

By “heterocyclyl” is meant a non-aromatic cyclic group in which the ring atoms include at least one carbon and at least one O, N, or S atom, provided that at least three ring atoms are present. Exemplary heterocyclyl groups include epoxide, thiiranyl, aziridinyl, azetidinyl, thietanyl, dioxetanyl, morpholinyl, thiomorpholinyl, piperazinyl, piperidinyl, pyrrolidinyl, tetrahydropyranyl, tetrahydrofuranyl, dihydrofuranyl, tetrahydrothienyl, dihydrothienyl, dihydroindolyl, tetrahydroquinolyl, tetrahydroisoquinolyl, pyranyl, pyrazolinyl, pyrazolidinyl, dihydropyranyl, tetrahydroquinolyl, imidazolinyl, imidazolidinyl, pyrrolinyl, oxazolidinyl, isoxazolidinyl, thiazolidinyl, isothiazolidinyl, dithiazolyl, and 1,3-dioxanyl. Heterocyclyl groups may be optionally substituted with one or more substituents. By an “oxygen protecting group” is meant those groups intended to protect an oxygen containing (e.g., phenol, hydroxyl, or carbonyl) group against undesirable reactions during synthetic procedures. Commonly used oxygen protecting groups are disclosed in Greene, “Protective Groups in Organic Synthesis,” 3rd Edition (John Wiley & Sons, New York, 1999), which is incorporated herein by reference. Exemplary oxygen protecting groups include acyl, aryloyl, or carbamyl groups, such as formyl, acetyl, propionyl, pivaloyl, t-butylacetyl, 2-chloroacetyl, 2-bromoacetyl, trifluoroacetyl, trichloroacetyl, phthalyl, o-n itrophenoxyacetyl, a-chlorobutyryl, benzoyl, 4-chlorobenzoyl, 4-bromobenzoyl, t-butyldimethylsilyl, tri-iso-propylsilyloxymethyl, 4,4′-dimethoxytrityl, isobutyryl, phenoxyacetyl, 4-isopropylpehenoxyacetyl, dimethylformamidino, and 4-nitrobenzoyl; alkylcarbonyl groups, such as acyl, acetyl, propionyl, and pivaloyl; optionally substituted arylcarbonyl groups, such as benzoyl; silyl groups, such as trimethylsilyl (TMS), tert-butyldimethylsilyl (TBDMS), tri-iso-propylsilyloxymethyl (TOM), and triisopropylsilyl (TIPS); ether-forming groups with the hydroxyl, such methyl, methoxymethyl, tetrahydropyranyl, benzyl, p-methoxybenzyl, and trityl; alkoxycarbonyls, such as methoxycarbonyl, ethoxycarbonyl, isopropoxycarbonyl, n-isopropoxycarbonyl, n-butyloxycarbonyl, isobutyloxycarbonyl, sec-butyloxycarbonyl, t-butyloxycarbonyl, 2-ethylhexyloxycarbonyl, cyclohexyloxycarbonyl, and methyloxycarbonyl; alkoxyalkoxycarbonyl groups, such as methoxymethoxycarbonyl, ethoxymethoxycarbonyl, 2-methoxyethoxycarbonyl, 2-ethoxyethoxycarbonyl, 2-butoxyethoxycarbonyl, 2-methoxyethoxymethoxycarbonyl, al lyloxycarbonyl, propargyloxycarbonyl, 2-butenoxycarbonyl, and 3-methyl-2-butenoxycarbonyl; haloalkoxycarbonyls, such as 2-chloroethoxycarbonyl, 2-chloroethoxycarbonyl, and 2,2,2-trichloroethoxycarbonyl; optionally substituted arylalkoxycarbonyl groups, such as benzyloxycarbonyl, p-methylbenzyloxycarbonyl, p-methoxybenzyloxycarbonyl, p-nitrobenzyloxycarbonyl, 2,4-dinitrobenzyloxycarbonyl, 3,5- dimethylbenzyloxycarbonyl, p-chlorobenzyloxycarbonyl, p-bromobenzyloxy-carbonyl, and fluorenylmethyloxycarbonyl; and optionally substituted aryloxycarbonyl groups, such as phenoxycarbonyl, p-nitrophenoxycarbonyl, o-nitrophenoxycarbonyl, 2,4-dinitrophenoxycarbonyl, p-methyl-phenoxycarbonyl, m-methylphenoxycarbonyl, o-bromophenoxycarbonyl, 3,5-dimethylphenoxycarbonyl, p-chlorophenoxycarbonyl, and 2-chloro-4-nitrophenoxy-carbonyl); substituted alkyl, aryl, and alkaryl ethers (e.g., trityl; methylthiomethyl; methoxymethyl; benzyloxymethyl; siloxymethyl; 2,2,2,-trichloroethoxymethyl; tetrahydropyranyl; tetrahydrofuranyl; ethoxyethyl; 1-[2-(trimethylsilyl)ethoxy]ethyl; 2-trimethylsilylethyl; t-butyl ether; p-chlorophenyl, p-methoxyphenyl, p-nitrophenyl, benzyl, p-methoxybenzyl, and nitrobenzyl); silyl ethers (e.g., trimethylsilyl; triethylsilyl; triisopropylsilyl; dimethylisopropylsilyl; t-butyldimethylsilyl; t-butyldiphenylsilyl; tribenzylsilyl; triphenylsilyl; and diphenymethylsilyl); carbonates (e.g., methyl, methoxymethyl, 9-fluorenylmethyl; ethyl; 2,2,2-trichloroethyl; 2-(trimethylsilyl)ethyl; vinyl, allyl, nitrophenyl; benzyl; methoxybenzyl; 3,4-dimethoxybenzyl; and nitrobenzyl); carbonyl-protecting groups (e.g., acetal and ketal groups, such as dimethyl acetal, and 1,3-dioxolane; acylal groups; and dithiane groups, such as 1,3-dithianes, and 1,3-dithiolane); carboxylic acid-protecting groups (e.g., ester groups, such as methyl ester, benzyl ester, t-butyl ester, and orthoesters; and oxazoline groups..

By a “nitrogen protecting group” is meant those groups intended to protect an amino group against undesirable reactions during synthetic procedures. Commonly used nitrogen protecting groups are disclosed in Greene, “Protective Groups in Organic Synthesis,” 3rd Edition (John Wiley &

Sons, New York, 1999), which is incorporated herein by reference. Nitrogen protecting groups include acyl, aryloyl, or carbamyl groups such as formyl, acetyl, propionyl, pivaloyl, t-butylacetyl, 2-chloroacetyl, 2-bromoacetyl, trifluoroacetyl, trichloroacetyl, phthalyl, o-nitrophenoxyacetyl, a- chlorobutyryl, benzoyl, 4-chlorobenzoyl, 4-bromobenzoyl, 4-nitrobenzoyl, and amino acids such as alanine, leucine, and phenylalanine; sulfonyl-containing groups such as benzenesulfonyl, and p-toluenesulfonyl; carbamate forming groups such as benzyloxycarbonyl, p-chlorobenzyloxycarbonyl, p-methoxybenzyloxycarbonyl, p-nitrobenzyloxycarbonyl, 2-nitrobenzyloxycarbonyl, p-bromobenzyloxycarbonyl, 3,4-dimethoxybenzyloxycarbonyl, 3,5-dimethoxybenzyloxycarbonyl, 2,4-dimethoxybenzyloxycarbonyl, 4-methoxybenzyloxycarbonyl, 2-nitro-4,5-dimethoxybenzyloxycarbonyl, 3,4,5-trimethoxybenzyloxycarbonyl, 1-(p-biphenylyl)-1-methylethoxycarbonyl, a,a-dimethyl-3,5-dimethoxybenzyloxycarbonyl, benzhydryloxy carbonyl, t-butyloxycarbonyl, diisopropylmethoxycarbonyl, isopropyloxycarbonyl, ethoxycarbonyl, methoxycarbonyl, allyloxycarbonyl, 2,2,2,-trichloroethoxycarbonyl, phenoxycarbonyl, 4-nitrophenoxy carbonyl, fluorenyl-9-methoxycarbonyl, cyclopentyloxycarbonyl, adamantyloxycarbonyl, cyclohexyloxycarbonyl, and phenylthiocarbonyl, alkaryl groups such as benzyl, triphenylmethyl, and benzyloxymethyl, and silyl groups, such as trimethylsilyl. Preferred nitrogen protecting groups are alloc, formyl, acetyl, benzoyl, pivaloyl, t-butylacetyl, alanyl, phenylsulfonyl, benzyl, t-butyloxycarbonyl (Boc), and benzyloxycarbonyl (Cbz).

As noted, substituents may be optionally substituted with halo, optionally substituted C₃-io carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; -CN; -NO₂; -ORₐ; -N(Rₐ)₂; -C(═O)Rₐ; -C(═O)ORₐ; -S(═O)2Rₐ; -S(═O)2ORₐ; -P(═O)Rₐ₂; -O-P(═O)(ORₐ)2, or -P(═O)(ORₐ)2, or an ion thereof; wherein each Rₐ is independently H, C₁₋₆ alkyl; optionally substituted C₃₋₁₀ carbocyclyl; optionally substituted C₁₋₉ heterocyclyl having one to four heteroatoms independently selected from 0,

N, and S; optionally substituted C₆₋₂₀ aryl; optionally substituted C₁₋₉ heteroaryl having one to four heteroatoms independently selected from O, N, and S; an oxygen protecting group; or a nitrogen protecting group. Cyclic substituents may also be substituted with C₁₋₆ alkyl. In specific embodiments of alloxazines, substituents may include optionally substituted with halo, optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; -NO₂; -ORₐ; -N(Rₐ)₂; -C(═O)Rₐ; -C(═O)ORₐ; -S(═O)2Rₐ; -S(═O)2ORₐ; -P(═O)Rₐ₂; -O-P(═O)(ORₐ)2, or -P(═O)(ORₐ)2, or an ion thereof; wherein each Rₐ is independently H, C₁₋₉ alkyl; optionally substituted C₃₋₁₀ carbocyclyl; optionally substituted C₁₋₉ heterocyclyl having one to four heteroatoms independently selected from O, N, and S;

optionally substituted C₆₋₂₀ aryl; optionally substituted C₁₋₉ heteroaryl having one to four heteroatoms independently selected from O, N, and S; an oxygen protecting group; or a nitrogen protecting group, and cyclic substituents may also be substituted with C₁₋₆ alkyl. In specific embodiments of quinones, alkyl groups may be optionally substituted with one, two, three, or, in the case of alkyl groups of two carbons or more, four substituents independently selected from the group consisting of halo, hydroxyl, C₁₋₆ alkoxy, SO₃H, amino, nitro, carboxyl, phosphoryl, phosphonyl, thiol, C₁₋₆ alkyl ester, optionally substituted C₁₋₆ alkyl thio, and oxo, or an ion thereof.

Exemplary ions of substituent groups are as follows: an exemplary ion of hydroxyl is -—O⁻; an exemplary ion of -COON is -000⁻; exemplary ions of -PO3H2 are -POSH⁻and -PO3²⁻; an exemplary ion of -PO3HRₐ is -PO3Rₐ⁻, where Rₐ is not H; exemplary ions of -PO4H₂ are -PO4H and -PO4²⁻; and an exemplary ion of —SO₃H is —SO₃.

### BRIEF DESCRIPTION OF THE DRAWINGS

FIG. 1. Pourbaix diagram of 2,6-DHAQ. Above pH -11.7, the equilibrium potential of 2,6-DHAQ is pH-independent, indicating that both oxidized and reduced forms are fully deprotonated. FIGS. 2a-d. a. Cyclic voltammogram of 2 mM 2,6-DHAQ (left curve) and ferrocyanide (right curve) scanned at 100 mV/s; arrows indicate scan direction. Dotted line represents cyclic voltammogram of 1 M KOH background scanned at 100 mV/s. b and c. Cyclic voltammograms of 2,3,6,7-THAQ (left curve in b) and 1,5-DMAQ (left curve in c), respectively, plotted along ferrocyanide (right curve) scanned at 100 mV/s on glassy carbon electrode. Both 2,6-DHAQ derivatives/ferrocyanide couples showed higher equilibrium potential than 2,6-DHAQ/ferrocyanide. d.

Selected aqueous secondary batteries showing voltage and flow status.

FIGS. 3a-3d. a. Rotating disk electrode study of the reduction of a 1 mM solution of 2,6-DHAQ in 1 M KOH on a glassy carbon electrode at various rotation rates (curves from top to bottom in legend). b. Levich plot of 1 mM 2,6-DHAQ in 1 M KOH. Data are an average of the current at -1.187 V vs. SHE for each of three runs; error bars indicate the standard deviation. c. Cyclic voltammogram of 1 mM 2,6-DHAQ in 1 M KOH (solid line). Dashed lines represent simulated cyclic voltammograms of a two-electron reduction of varying electrochemical rate constant ko and a reduction potential Eo of -0.684 V vs. SHE. The simulations assumed a ═0.5. The scan rate in all cases was 25 mV s⁻¹. d. Cyclic voltammogram of 1 mM 2,6-DHAQ in 1 M KOH (solid line). Dashed lines represent the simulated components of two successive one-electron reductions with reduction potentials of -0.657 V vs. SHE and -0.717 V vs. SHE, respectively, as well as the simulated total current arising from such a reaction. Each simulated reduction has a rate constant ko ═7 x 10⁻³ cm 5⁻¹. The simulations assumed a ═0.5.

FIG. 4. Flow Cell Schematic of battery in a discharged state containing riboflavin 5′ phosphate (FMN), as negative electrolyte, and ferrocyanide (Fe(CN)6⁴⁻), as positive electrolyte, in aqueous potassium hydroxide (KOH) solution.

FIG. 5. Cyclic voltammogram of 2 mM FMN (left curve) and ferrocyanide (right curve) scanned at 100 mV/s on glassy carbon electrode; arrows indicate scan direction.

FIGS. 6a-6b. (a) The open circuit potential (OCP) versus the state of charge (SOC) of a low concentration FMN (0.5 M)-ferrocyanide (0.4 M) cell. (b) Polarization curves and power density of the cell at three different states of charge.

WO 2016/144909 PCT/US2016/021253

FIGS. 7a-7b. (a) Cycling Performance of a FMN-ferrocyanide cell charged and discharged at 100 mA cm⁻², switching between charge/discharge when voltage exceeds 1.45 V on charging and is below 0.6 V on discharge. (b) Plot of the capacity retention, coulombic efficiency, and overall energy efficiency per cycle of the battery upon repeated cycling at 100 mA cm⁻². FIGS. 8a-8b. (a) Polarization curves and power density of the cell at three different states of charge. (b) The open circuit potential (OCP) versus the state of charge (SOC) of a high concentration FMN (1 M)-ferrocyanide (1 M) cell.

FIG. 9. ¹H NMR spectra of isomeric structures alloxazine 7-carboxylic acid and alloxazine 8-carboxylic acid (ACA).

FIGS. 10a-10b. (a) Cycling Performance of an ACA-ferrocyanide cell charged and discharged at 100 mA cm⁻², switching between charge/discharge when voltage exceeds 1.75 V on charging and is below 0.5 V on discharge. (b) Plot of the capacity retention, coulombic efficiency, and overall energy efficiency per cycle of the battery upon repeated cycling at 100 mA cm⁻².

FIG. 11. ¹H NMR spectra of isomeric structures 7-hydroxyalloxazine and 8-hydroxyalloxazine.

FIGS. 12a and 12b. a. Schematic of cell in charge mode. Cartoon on top of the cell represents sources of electrical energy from wind and solar. Curved arrows indicate direction of electron flow and white arrows indicate electrolyte solution flow. Gray arrow indicates migration of cations across the membrane. Essential components of electrochemical cells are labeled. The molecular structures of oxidized and reduced species are shown on corresponding reservoirs. b. Flow

Cell Schematic of battery in a discharged state containing 2,6-DHAQ and potassium ferrocyanide (K4Fe(CN)6) in aqueous potassium hydroxide (KOH) solution.

FIGS. 13a-13c. Cell Performance. a, Cell OCP vs. SOC. All potentials were taken when cell voltage plateaued after the preceding charging step. 100% SOC was approximated when the 1.6 V limit was exceeded during the final charging step. b and c, Cell voltage & power density vs. current density at 20° C. and 45° C., respectively, at 10%, 50%, and -100% SOC. Electrolyte composition: At 20° C., 0.5 M 2,6-DHAQ and 0.4 M ferrocyanide were used in negolyte and posolyte, respectively. At 45° C., both concentrations were doubled. In both cases, potassium hydroxide content started at 1 M for both sides in the fully discharged state. In b, the bottom curve is 10%, the middle curve is 50%, and the top curve is 100%. In c, for both axes, the bottom curve is 10%, the middle curve is 50%, and the top curve is 100%.

FIGS. 14a-14b. Cell Cycling Performance. a, Representative voltage vs. time curves during 100 charge-discharge cycles at 0.1 A/cm², recorded between the 10th and 19th cycles. b, Cumulative capacity retention, current efficiency and energy efficiency values of 100 cycles. Capacity retention is evaluated for discharge, based on the capacity of the 1St discharge cycle.

FIGS. 15a-15c. Chemical and electrochemical stability of 2,6-DHAQ. ¹H NMR (500 MHz, DMSO-d6) spectra. a. 2,6-DHAQ 6: 8.04 (d, 2H, J═8.3 Hz, 2 x ArCH), 7.47 (d, 2H, J═2.5 Hz, 2 x ArCH), 7.19 (dd, 2H, J═8.3, 2.5 Hz, 2 x ArCH). b. 2,6-DHAQ, after 30 days heating in 5 M KOH solution at 100° C. c. 2,6-DHAQ, after 100 charge-discharge cycles.

FIGS. 16a-16b. Test of electrolyte permeation through membrane. Full (a) and zoomed in (b) cyclic voltammograms of 0.4 M ferro-ferricyanide electrolyte after 100 charge-discharge cycles. Same posolyte to which was added 3.9 mM 2,6-DHAQ, and 7.6 mM 2,6-DHAQ.

FIGS. 17a-17b. Leakage of electrolyte into gaskets. Image showing the Teflon gaskets and graphite flow plates before (a) and after cell cycling (b). Discolored area indicates leakage of the negative electrolyte (top plate: negative side; bottom plate: positive side) leading to capacity fade.

FIG. 18. Electrochemical impedance spectroscopy (Nyquist plot). Frequency decreases from left to right. The high frequency area-specific resistance (NO values discussed in the main text are obtained by fitting the high frequency parts to a resistor (NO in series with an inductance component. The inductance came from thick cables and current collectors that connect the cell to the potentiostat. The rhf includes contributions from the Nafion membrane, carbon electrodes, and electrical leads between the cell and the potentiostat. The rhf values at two different temperatures are indicated within the figure.

FIG. 19. Background cyclic voltammograms. Cyclic voltammograms of 1 M KOH and 1 M H2504 background scanned at 100 mV/s using graphite foil electrode. Dashed lines indicate commonly-reported equilibrium potentials of water splitting reactions. This illustrates the practical stability window for aqueous flow batteries.

FIGS. 20a-20c. Synthetic scheme and NMR characterization of 2,3,6,7-tetrahydroxyanthraquinone (2,3,6,7-THAQ). a. Synthetic scheme of 2,3,6,7-THAQ from inexpensive, commodity chemicals. i. condensation with acetaldehyde to afford 2,3,6,7-tetramethoxydimethylanthracene (MeCHO, H2504), ii. oxidation to afford 2,3,6,7- tetramethoxyanthraquinone (Na2Cr2O7 in acetic acid), iii. hydrolysis of methoxy (HBr, reflux). b. ¹H-NMR (500 MHz, DMSO) spectrum of 2,3,6,7-THAQ 6: 10.42 (br, 4H, 4 x ArOH), 7.43 (s, 4H, 4 x ArCH). c. ¹³C-NMR (125 MHz) spectrum 6: 181.50, 151.23, 127.46, 113.31, 113.28. Solvent peaks are labeled with asterisks.

FIGS. 21a-21c. Synthetic scheme and NMR characterization of 1,5-dimethyl-2,6-dihydroxyanthraquinone (1,5-DMAQ). a. Synthetic scheme of 1,5-DMAQ from inexpensive, commodity chemicals. i. sulfonation of naphthalene to afford 1,3,5-naphthalenetrisulfonic acid (H2504/503), ii. preparation of sodium salt to afford trisodium naphthalene-1,3,5-trisulfonate (NaOH), iii. reaction of trisodium naphthalene-1,3,5-trisulfonate with alkali (NaOH in autoclave at higher temperature, 280-310° C.), iv. dimeration to afford 1,5-DMAQ (A1C₁₃-NaCl melt). b. ¹H-NMR (500 MHz, DMSO-d6) spectrum of 1,5-DMAQ 6: 10.78 (br, 2H, 2 x ArOH), 7.93 (d, 2H, J═8.5 Hz, 2 x ArCH), 7.21 (d, 2H, J═8.5 Hz, 2 x ArCH), 2.55 (s, 6H, 2 x ArCH3). c. ¹³C-NMR (125 MHz, DMSO-d6) spectrum 6: 185.63, 161.87, 133.10, 128.94, 128.04, 126.74, 119.83, 14.03. Solvent peaks are labeled with asterisks. Mass spectroscopy: C₆I⁻11204 M-H calculated 267.0657 found 267.0659.

FIGS. 22a-22b. NMR spectra of 1,5-dimethyl-2,6-dihydroxy-9,10-anthraquinone using (a) protons and (b) carbon 13.

### DETAILED DESCRIPTION OF THE INVENTION

The invention provides rechargeable batteries employing organic compounds (e.g., quinones or alloxazines) as redox active species and operated at high pH, i.e., pH above 7. When compounds such as quinones and alloxazines are dissolved in basic solution, various groups become deprotonated, and the molecular ions become more soluble in aqueous media. This deprotonation also causes the reduction potentials to shift to more negative values. For example, functionalization of 9,10-anthraquinone (AQ) with electron donating groups such as OH has been shown to lower the reduction potential and expand the battery voltage (Huskinson, B. et al. Nature 505, 195-198 (2014)).

In alkaline solution, these OH groups are deprotonated into alkoxides that provide solubility and greater electron donation capability. When combined, e.g., with a positive ferricyanide/ferrocyanide redox couple, a flow battery with a potential over 1 volt is accessible. We have investigated several molecules dissolved in water at a basic pH, such as greater than or equal to 14, and each surprisingly gives battery voltages between 0.8 and 1.5 volts versus ferricyanide/ferrocyanide.

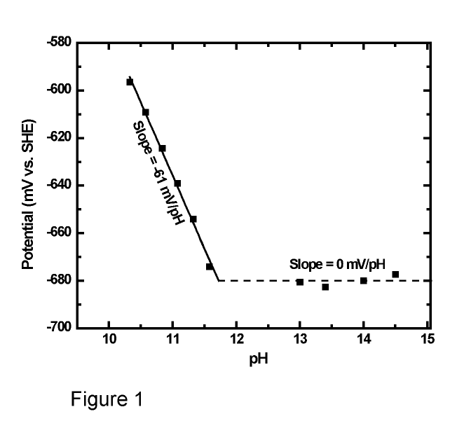

For example, in acid solutions, AQ undergoes a two electron two proton reduction at a single potential, which shifts to more negative values as the pH increases. When the pH exceeds 12 the reduction potential of 2,6-dihydroxy-9,10-anthraquinone (2,6-DHAQ) becomes pH independent because the reduced species is generated in its fully deprotonated form (FIG. 1). In contrast with the pH dependent electrochemical behavior of, e.g., quinones (negative terminal), the ferro/ferricyanide redox couple (positive terminal) has a pH independent redox potential. This contrasting pH dependence permits us to further expand the cell voltage by developing low reduction potential quinones at high pH.

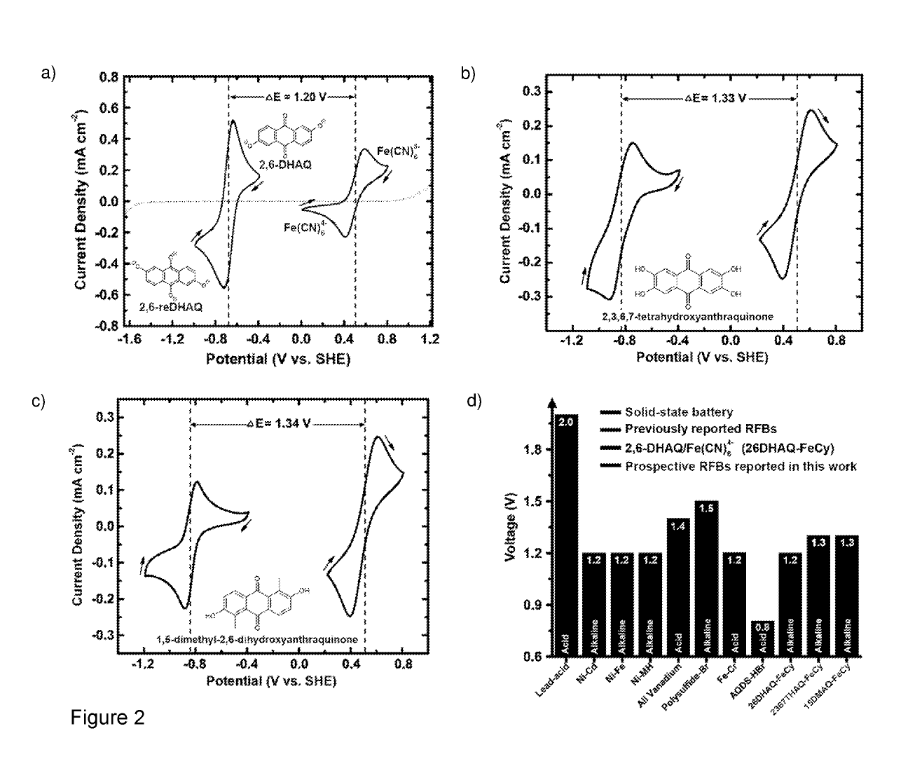

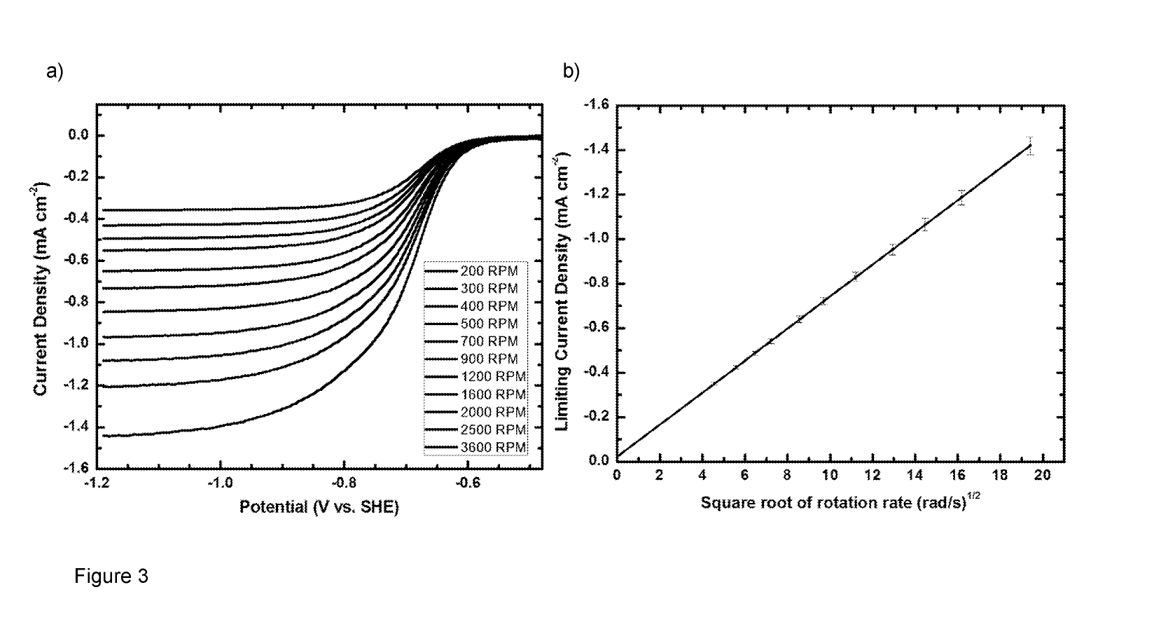

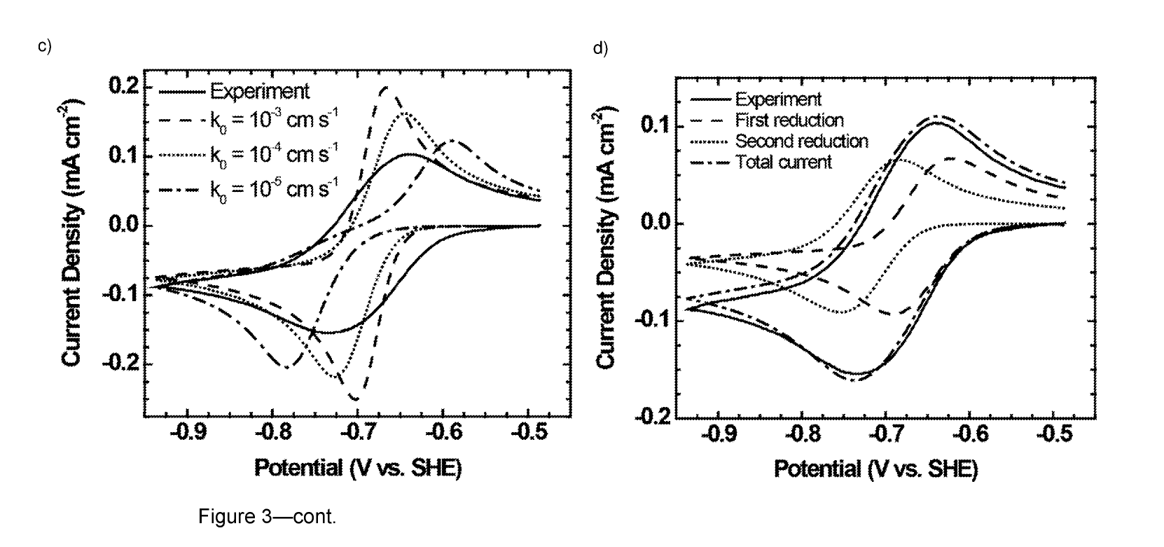

The practical kinetic aqueous stability window in base is enlarged compared to in acid due to the sluggish kinetics of the hydrogen evolution reaction on carbon electrodes. Because of this, organic compounds (e.g., quinones and alloxazines) with substantially more negative reduction potentials are feasible as negative materials. For example, the cyclic voltammograms (CVs) of 2,6-DHAQ and ferro/ferricyanide suggest an equilibrium cell potential of 1.2 V upon combination of these two half-reactions (FIG. 2a); the CV's of 2,3,6,7-tetrahydroxy-AQ and 1,5-dimethyl-2,6-DHAQ suggest cell potentials vs. ferri/ferrocyanide approaching 1.35 V (FIGS. 2b-2c). A quantitative analysis of the CV of 2,6-DHAQ at pH 14 (FIGS. 3a-3d) revealed consistency with two one-electron reductions at potentials separated by only 0.06 V with kinetic rate constants as high as for quinones in acid (Huskinson, B. et al. Nature 505, 195-198 (2014)).

The invention points the way to a high efficiency, long cycle life redox flow battery with reasonable power cost, low energy cost, and all the energy scaling advantages of a flow battery. In some embodiments, the separator can be a cheap hydrocarbon instead of a fluorocarbon, and reactant crossover will be negligible. In other embodiments, the separator can be a porous physical barrier instead of an ion-selective membrane. The electrodes can be inexpensive conductors, such as carbon. Many of the structural components can be made of cheap plastic, and components that need to be conducting can be protected with conformally coated ultrathin films. Chemical storage can be in the form of inexpensive, flowing liquids held in cheap plastic tanks and require neither pressurization nor heating above the liquid's boiling point. Alloxazine-to-hydroalloxazine or quinone-to-hydroquinone cycling occurs rapidly and reversibly and provides high current density (high current density is very important because the cost per kW of the system is typically dominated by the electrochemical stack's cost per kW, which is inversely proportional to the power density -the product of current density and voltage), high efficiency, and long lifetime in a flow battery. Further, quinones and alloxazine structures can be readily screened computationally and synthesized.

In addition to redox potential, important molecular characteristics include solubility, stability, redox kinetics, toxicity, and potential or current market price. High solubility is important because the mass transport limitation at high current density in a full cell is directly proportional to the solubility.

Solubility can be enhanced by attaching polar groups such as the sulfonic acid groups or hydroxyl groups which can deprotonate at high pH. For example, commercially available 2,6-DHAQ, which includes two hydroxyl groups away from the ketone groups, exhibits a room temperature solubility of >0.6 M in 1 M KOH. Stability is important not only to prevent chemical loss for long cycle life, but also because polymerization on the electrode can compromise the electrode's effectiveness. Stability against water and polymerization can be enhanced by replacing vulnerable C-H groups with more stable groups as described herein, e.g., with C₁₋₆ alkyl, -COOH, or -OH.

Organic compounds usable in the invention include those of formula (I):

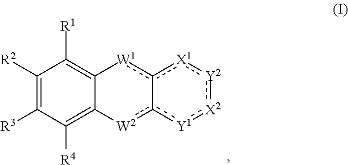

wherein iv) W¹ and W² are -C═O, and Y¹ is -C(R⁵)-, X2 ^{is} -O(R⁶)-, Y2 ^{is} -O(R⁷)-, and X¹ is -C(R⁹)-; v) X¹ and X² are -C═O, W¹ and W² are -N-, Y¹ is -N(R⁹)-, and Y² is -N(R¹⁰)-; or vi) X¹ and X² are -C═O, W² is -N(R⁹)-, Y² is -N(R¹⁰)-, and W¹ and Y¹ are -N-, wherein bonds shown with dashed lines are single or double bonds, and wherein each of R⁹ and R¹⁰, if present, is independently H; halo; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; -C(═O)Rₐ; and -C(═O)ORₐ; and each of R¹, R², R3, ^{R4,} R⁵, R⁶, R⁷ and R⁸, if present, is independently H; halo; optionally substituted C₁₋₆ alkyl; oxo; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; -CN; -NO₂; -ORₐ; -N(Rₐ)₂; -C(═O)Rₐ; -C(═O)ORₐ; -S(═O)2Rₐ; -S(═O)20Rₐ; -P(═O)Rₐ₂; and -P(═O)(ORₐ)₂; or any two adjacent groups selected from R¹, R², R³, and

R⁴ are joined to form an optionally substituted 3-6 membered ring, or an ion thereof;

wherein each Rₐ is independently H; C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group. Fused rings formed by adjacent groups of R¹, R², R³, and R⁴ may be carbocyclyl, aryl, heteroaryl, or heterocyclyl, as defined herein.

In particular embodiments, each of R1, R2_{,} R3_{,} R4, _{R5,} ^{R6,} R⁷ and R⁸, if present, is independently selected from H, hydroxyl, optionally substituted C₁₋₄ alkyl, carboxyl, and SO₃H, such as each of R¹, R², R3, ^{R4,} _{R5,} ^{R6,} R⁷ and R⁸, if present, being independently selected from H, hydroxyl, optionally substituted C₁₋₄ alkyl (e.g. methyl), and oxo, or an ion thereof. In some embodiments, R⁹ and R¹⁰ are independently, H, optionally substituted C₁₋₄ alkyl, or carboxyl, e.g., H or methyl. In some embodiments, the compound is substituted with at least one hydroxyl group.

In some embodiments, the compound is a quinone (e.g., an anthraquinone) of formula (II):

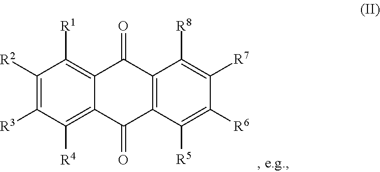

wherein each of R1, R2_{,} R3_{,} R4, _{R5,} ^{R6,} R⁷ and R⁸ is independently selected from H, optionally substituted C₁₋₆ alkyl, halo, hydroxyl, optionally substituted C₁₋₆ alkoxy, SO₃H, amino, nitro, carboxyl, phosphoryl, phosphonyl, and oxo, or an ion thereof.

In particular embodiments, each of R1, R2_{,} R3_{,} R4, _{R5,} ^{R6,} R⁷, and R⁸ is independently selected from H, hydroxyl, optionally substituted C₁₋₄ alkyl, carboxyl, and SO₃H, such as each of R¹, R², R³, R⁴,

R⁵, R⁶, R⁷ and R⁸ being independently selected from H, hydroxyl, optionally substituted C₁₋₄ alkyl (e.g. methyl), and oxo.

In other embodiments, the quinone, e.g., an anthraquinone, such as a 9,10-anthraquinone, is substituted with at least one hydroxyl group and optionally further substituted with a C₁₋₄ alkyl, such as methyl. Exemplary quinones include 2,6-dihydroxy-9,10-anthraquinone (2,6-DHAQ), 1,5-dimethyl-2,6-dihydroxy-9,10-anthraquinone, 2,3,6,7-tetrahydroxy-9,10-anthraquinone, 1,3,5,7-tetrahydroxy-2,4,6,8-tetramethyl-9,10-anthraquinone, and 2,7-dihydroxy-1,8-dimethyl-9,10-anthraquinone. Other quinones are shown in Table 1 below. Ions and reduced species thereof are also contemplated.

TABLE 1
(II)

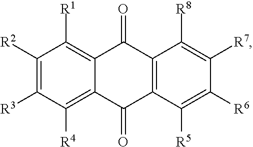

| -R substituted | R₁ | R₂ | R₃ | R₄ | R₅ | R₆ | R₇ | R₈ |
|---|---|---|---|---|---|---|---|---|
| Di- | H | OH | H | H | H | H | H | H |
| | H | SO₃H | H | H | H | H | H | H |
| | OH | OH | H | H | H | H | H | H |
| | OH | H | OH | H | H | H | H | H |
| | OH | H | H | OH | H | H | H | H |
| | OH | H | H | H | OH | H | H | H |
| | OH | H | H | H | H | H | OH | H |
| | OH | H | H | H | H | H | H | OH |
| | H | OH | H | H | H | OH | H | H |
| | H | OH | H | H | H | H | OH | H |
| | H | SO₃H | H | H | H | H | SO₃H | H |
| Tri- | OH | OH | OH | H | H | H | H | H |
| | OH | OH | H | OH | H | H | H | H |
| | OH | OH | H | H | H | OH | H | H |
| | OH | OH | H | H | H | H | OH | H |
| | OH | H | OH | H | H | H | H | OH |
| | OH | OH | SO₃H | H | H | H | H | H |
| | OH | SO₃H | H | OH | H | H | H | H |
| Tetra- | OH | OH | OH | OH | H | H | H | H |
| | OH | OH | H | H | OH | OH | H | H |
| | OH | OH | H | H | OH | H | H | OH |
| | OH | H | H | OH | OH | H | H | OH |
| | H | OH | OH | H | H | OH | OH | H |
| | OH | SO₃H | OH | OH | H | H | H | H |
| | OH | SO₃H | H | OH | H | SO₃H | H | H |
| | OH | SO₃H | H | OH | H | H | SO₃H | H |
| | OH | SO₃H | H | H | H | H | OH | SO₃H |
| Penta- | OH | SO₃H | OH | OH | H | SO₃H | H | H |
| | OH | SO₃H | OH | OH | H | H | SO₃H | H |

Particularly preferred quinones for use in this invention include 2,6-DMAQ, 1,5-dimethyl-2,6-dihydroxy-9,1 0-anthraquinone, 2 ,3,6,7-tetrahydroxy-9,1 0-anthraquinone, 1,3,5,7-tetrahydroxy-2,4,6,8-tetramethyl-9,1 0-anthraquinone, and 2,7-dihydroxy-1,8-dimethyl-9,1 0-anthraquinone. The methyl groups contribute to increasing the voltage and the stability of the flow battery, compared to similar anthraquinones with hydrogens in place of the methyl groups.

In some embodiments, the compound is an alloxazine of formula (III):

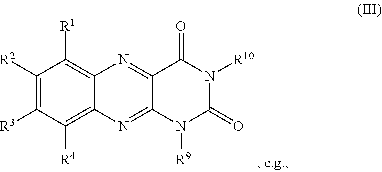

wherein each of R⁹ and R¹⁰ is independently H; optionally substituted C₁₋₆ alkyl (e.g., unsubstituted Ci-s alkyl); optionally substituted C₃₋₁₀ carbocyclyl; optionally substituted C₁₋₆ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; -C(═O)Rₐ; and -C(═O)ORₐ; and each of R¹, R², R³, and R⁴ is independently H; C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; -NO₂; -ORₐ; -N(Rₐ)₂; -C(═O)Rₐ; - C(═O)ORₐ; -S(═O)2Rₐ; -S(═O)2ORₐ; -P(═O)Rₐ₂; and -P(═O)(ORₐ)₂; or any two adjacent groups selected from R¹, R², R³, and R⁴ are joined to form an optionally substituted 3-6 membered ring, or an ion thereof;

wherein each Rₐ is independently H; C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group.

In some embodiments, each of R⁹ and R¹⁹ is independently H, optionally substituted C₁₋₆ alkyl, or -C(═O)ORₐ; and each of R¹, R², R³, and R⁴ is independently H, halo, optionally substituted C₁₋₆ alkyl, -NO2, -ORₐ, -N(Rₐ)2, -C(═O)ORₐ, -S(═O)20Rₐ, -P(═O)R_{a 2} or -P(═O)(ORₐ)₂; wherein each Rₐ is independently H or optionally substituted C₁₋₆ alkyl. In some embodiments, none of, any two of, any three of, any four of, any five of, or any six of R¹, R², R³, R⁴, R⁹, and R¹⁹ are H.

In some embodiments, the compound is an isoalloxazine of formula (IV):

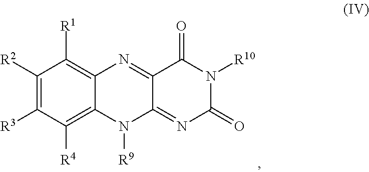

or a polymer e.g., dimer or trimer, of formula (V) or (VI):

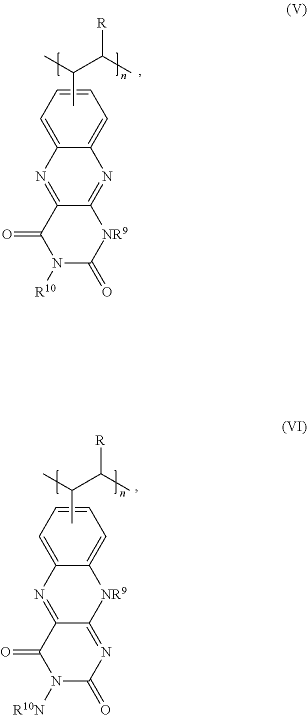

wherein n is an integer from 2 to 40; wherein R is a substituent that increase the aqueous solubility of the polymer, e.g., -OH, -COOH, -S03H, -N(Rₐ)2, and -P(═O)(ORₐ)2, where at least one Rₐ is H and other groups known in the art; and wherein other groups are as described herein. In preferred embodiments, one or both of R⁹ and R¹⁰ are H.

In some embodiments, the compound is riboflavin 5′ phosphate, having the formula

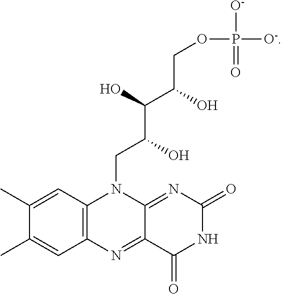

The methyl groups contribute to increasing the voltage and the stability of the flow battery, compared to similar alloxazines with hydrogens in place of the methyl groups. In some embodiments, the compound is a mixture of the isomeric structures alloxazine 7-carboxylic acid and alloxazine 8-carboxylic acid:

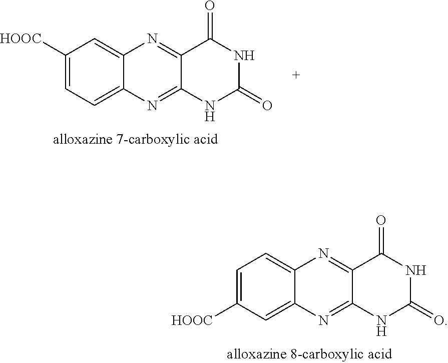 [SMILES: O=C(O)c1ccc2nc3[nH]c(=O)[nH]c(=O)c3nc2c1 ; O=C(O)c1ccc2nc3c(=O)[nH]c(=O)[nH]c3nc2c1]

In some embodiments, the compound is a mixture of the isomeric structures 7-hydroxyalloxazine and 8-hydroxyalloxazine:

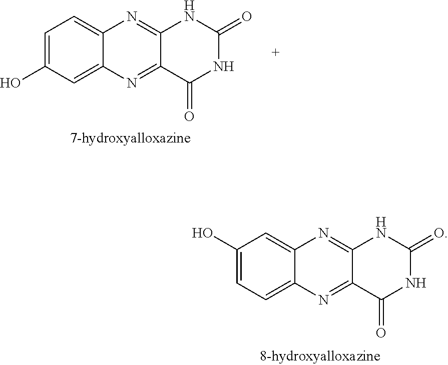 [SMILES: O=c1[nH]c(=O)c2nc3cc(O)ccc3nc2[nH]1 ; O=c1[nH]c(=O)c2nc3ccc(O)cc3nc2[nH]1]

In some embodiments, the compound of formula (I) is 7,8-dihydroxyalloxazine:

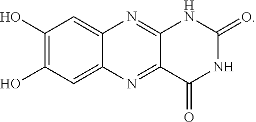 [SMILES: O=c1[nH]c(=O)c2nc3cc(O)c(O)cc3nc2[nH]1]

Ions and reduced species of the compounds described herein are also contemplated for use in the batteries and methods of the invention.

Organic compounds and/or ions thereof (e.g., alloxazines/hydroalloxazines and quinones/hydroquinones) are dissolved or suspended in aqueous solution in the batteries. The concentration of the organic compounds and/or ions thereof can range, for example, from 0.1-15 M, or from 0.1-10 M. In addition to water, solutions may include alcohols (e.g., methyl, ethyl, or propyl) and other co-solvents to increase the solubility of a particular alloxazine/hydroalloxazine or quinone/hydroquinone. In some embodiments, the solution is at least 10%, 20%, 30%, 40%, 50%, 60%, 70%, or 80% water, by mass. Alcohol or other co-solvents may be present in an amount required to result in a particular concentration of organic compound and/or ion thereof. The solution may or may not be buffered to maintain a specified pH. The pH of the aqueous solution is typically at least 7, e.g., at least 8, 9, 10, 11, 12, 13, or 14. Organic compounds and/or ions thereof may be present in a mixture.

Redox Active Species Organic compounds and/or ions thereof (e.g., alloxazines/hydroalloxazines or quinones/hydroquinones) may be employed on one side in conjunction with another redox active species, e.g., bromine, chlorine, iodine, oxygen, vanadium, chromium, cobalt, iron, e.g., ferricyanide/ferrocyanide, aluminum, e.g., aluminum(III) biscitrate monocatecholate, manganese, cobalt, nickel, copper, or lead, e.g., a manganese oxide, a cobalt oxide, or a lead oxide.

Electrode Materials

Electrode materials can be screened for fast molecule-specific electrode kinetics. Although evidence indicates that alloxazine/hydroalloxazine or quinone/hydroquinone catalysis is not a significant barrier, some electrode materials are expected to become deactivated due to the chemisorption of molecules or fragments, or the polymerization of reactants. Electrodes for use with an organic compound or ion thereof (e.g., alloxazine, hydroalloxazine, quinone, or hydroquinone) include any carbon electrode, e.g., glassy carbon electrodes, carbon paper electrodes, carbon felt electrodes, or carbon nanotube electrodes. Titanium electrodes may also be employed. Electrodes suitable for other redox active species are known in the art.

The fabrication of full cells requires the selection of appropriate electrodes. Electrodes can be made of a high specific surface area conducting material, such as nanoporous metal sponge (T. Wada, A.D. Setyawan, K. Yubuta, and H. Kato, Scripta Materialia 65, 532 (2011)), which has synthesized previously by electrochemical dealloying (J.D. Erlebacher, M.J. Aziz, A. Karma, N. Dmitrov, and K. Sieradzki, Nature 410, 450 (2001)), or conducting metal oxide, which has been synthesized by wet chemical methods (B.T. Huskinson, J.S. Rugolo, S.K. Mondal, and M.J. Aziz, arXiv:1206.2883 [cond-mat.mtrl-sci]; Energy & Environmental Science 5, 8690 (2012); S.K. Mondal, J.S. Rugolo, and M.J. Aziz, Mater. Res. Soc. Symp. Proc. 1311, GG10.9 (2010)). Chemical vapor deposition can be used for conformal coatings of complex 3D electrode geometries by ultra-thin electrocatalyst or protective films.

Fabrication of Testing Hardware and Cell Testing The balance of system around the cell includes fluid handling and storage, and voltage and round-trip energy efficiency measurements can be made. Systems instrumented for measurement of catholyte and anolyte (e.g., negolyte and posolyte) flows and pH, pressure, temperature, current density and cell voltage may be included and used to evaluate cells. Testing is performed as reactant and pH and the cell temperature are varied. In one series of tests, the current density is measured at which the voltage efficiency drops to 90%. In another, the round-trip efficiency is evaluated by charging and discharging the same number of amp-minutes while tracking the voltage in order to determine the energy conversion efficiency. This is done initially at low current density, and the current density is then systematically increased until the round-trip efficiency drops below 80%. Fluid sample ports can be provided to permit sampling of both electrolytes, which will allow for the evaluation of parasitic losses due to reactant crossover or side reactions. Electrolytes can be sampled and analyzed with standard techniques.

Ion Conducting Barriers The ion conducting barrier allows the passage of alkali ions, such as sodium or potassium, but not a significant amount of the quinone or alloxazine or other redox active species. Examples of ion conducting barriers are Nafion, i.e., sulfonated tetrafluoroethylene based fluoropolymer-copolymer, hydrocarbons, e.g., polyethylene, and size exclusion barriers, e.g., ultrafiltration or dialysis membranes with a molecular weight cut off of 100, 250, 500, or 1,000 Da. For size exclusion membranes, the required molecular weight cut off is determined based on the molecular weight of the organic compound (e.g., quinone or alloxazine) or other redox active species employed. Porous physical barriers may also be included, when the passage of redox active species is tolerable.

Additional Components A battery of the invention may include additional components as is known in the art. Alloxazines, hydroalloxazines, quinones, hydroquinones, and other redox active species dissolved or suspended in aqueous solution are housed in a suitable reservoir. A battery may further include pumps to pump aqueous solutions or suspensions past one or both electrodes. Alternatively, the electrodes may be placed in a reservoir that is stirred or in which the solution or suspension is recirculated by any other method, e.g., convection, sonication, etc. Batteries may also include graphite flow plates and corrosion-resistant metal current collectors.

### EXAMPLE 1

The positive electrolyte was prepared by dissolving potassium ferrocyanide trihydrate (1.9 g) and potassium ferricyanide (0.15 g) in 1 M KOH solution (11.25 mL) to afford a 0.4 M ferrocyanide +40 mM ferricyanide electrolyte solution. The negative electrolyte was prepared by dissolving riboflavin 5′ phosphate sodium salt (0.72 g) in 2 M KOH solution (3 mL) resulting a 0.5 M electrolyte solution.

The negative electrolyte was prepared at a fully oxidized state. The positive electrolyte contained 9% oxidized species.

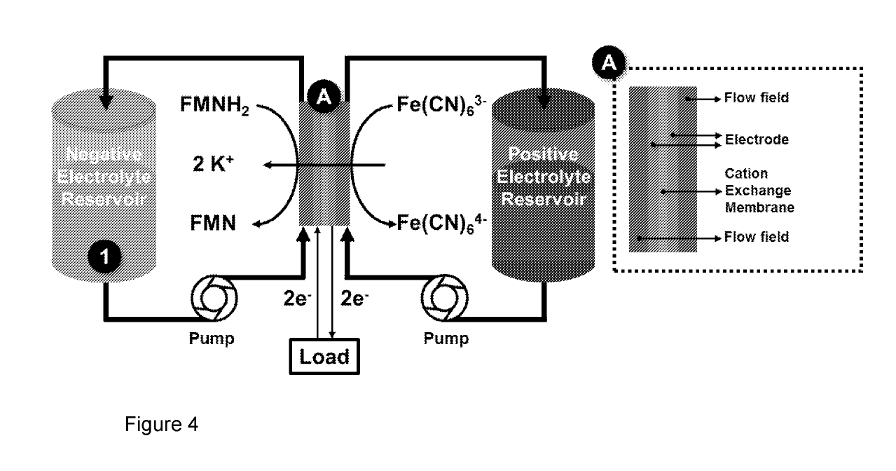

Hardware from Fuel Cell Tech. (NM, Albuquerque) was used to assemble a zero-gap flow cell configuration, similar to previous reports (Aaron, D. S. et al. Journal of Power Sources 206, 450-453 (2012)), and shown schematically in FIG. 4. Serpentine flow pattern flow plates were used for both sides. A 5 cm² geometric surface area electrode comprised a stack of three pieces of SGL Sigracet GDL 10AA porous carbon, and a piece of Nafion 212 membrane served as the ion-selective membrane. The rest of the space between the plates was gasketed by Kalrez sheets. The electrolytes were fed into the cell through PFA tubing, at a rate of 60 mL/min controlled by Cole-Parmer Micropump peristaltic pumps.

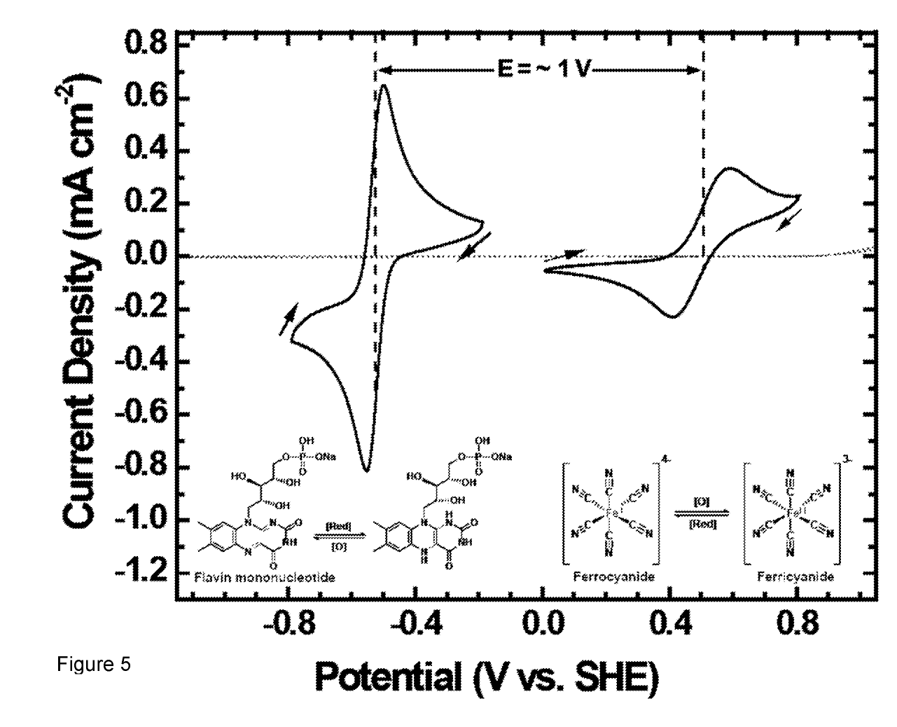

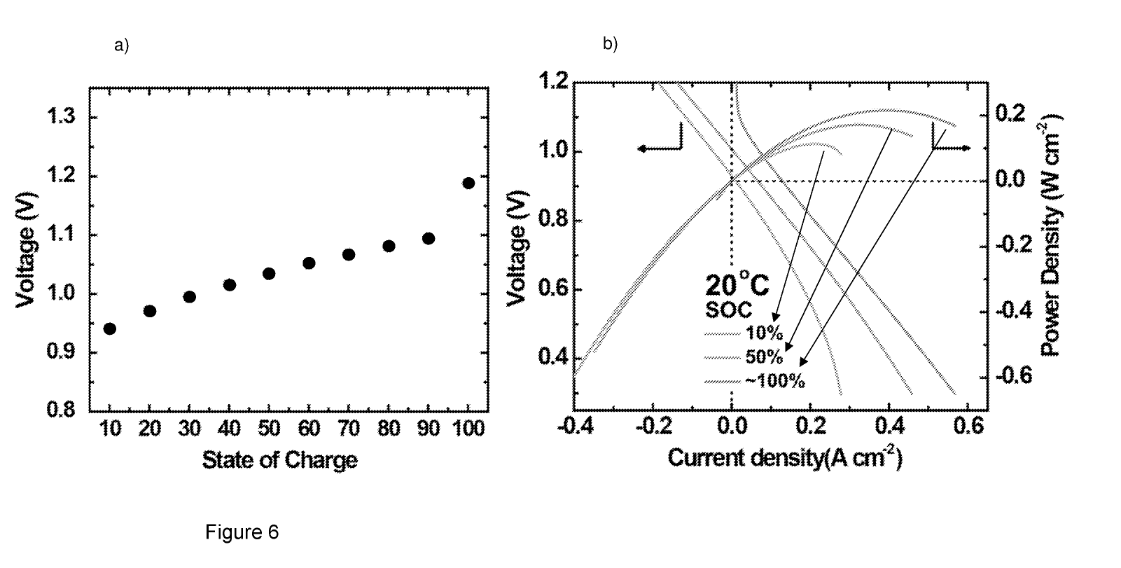

Before and during the test, the electrolytes were purged with UHP nitrogen to remove and then keep out atmospheric oxygen. Cyclic voltammograms of 2 mM FMN and ferrocyanide shown in FIG. 5 showed an overall peak separation of 1 V. Open-circuit potential measurements in FIG. 6a showed battery voltage above 1 V at 50% state of charge. Polarization curves in FIG. 6b showed a peak power density above 0.2 W cm⁻² at room temperature operation. Galvanostatic cycling shown in

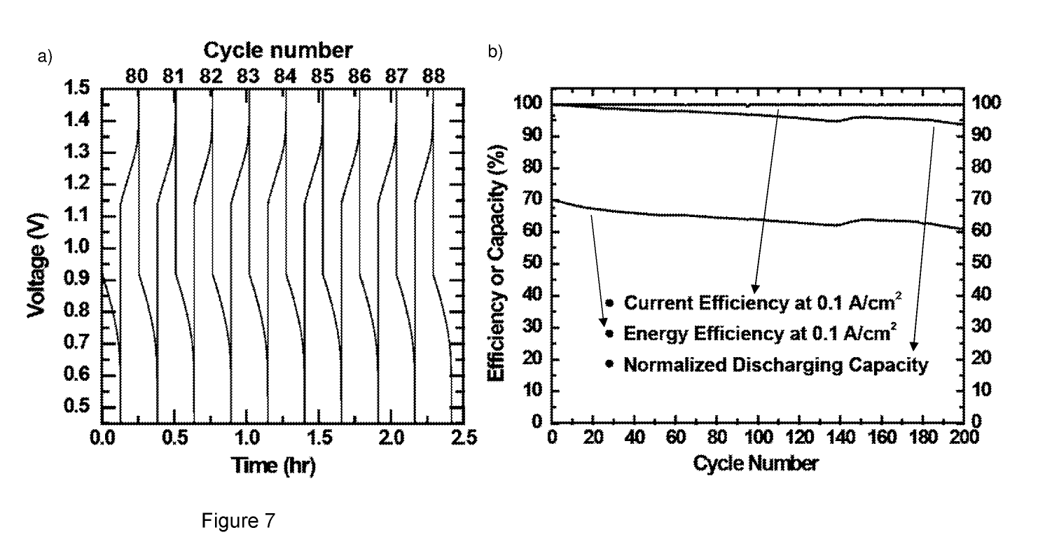

FIGS. 7a and 7b was done at 0.1 A/cm², between 0.4 and 1.5 V, controlled by a Gamry 30K Booster potentiostat.

### EXAMPLE 2

The positive electrolyte was prepared by dissolving potassium ferrocyanide trihydrate (3.2 g), sodium ferrocyanide decahydrate (3.6 g) and potassium ferricyanide (0.5 g) in 0.5 M KOH +0.5 M NaOH solution (15 mL) to afford a 1 M ferrocyanide +0.1 M ferricyanide electrolyte solution. The negative electrolyte was prepared by dissolving riboflavin 5′ phosphate sodium salt (2.4 g) in 4 M KOH solution (5 mL) resulting a 1 M electrolyte solution. The negative electrolyte was prepared in a fully oxidized state. The positive electrolyte contained 9% oxidized species.

Hardware from Fuel Cell Tech. (NM, Albuquerque) was used to assemble a zero-gap flow cell configuration, similar to previous reports (Aaron, D. S. et al. Journal of Power Sources 206, 450-453 (2012)), and shown schematically in FIG. 4. Serpentine flow pattern flow plates were used for both sides. A 5 cm² geometric surface area electrode comprised a stack of three pieces of SGL Sigracet GDL 10AA porous carbon, and a piece of Nafion 212 membrane served as the ion-selective membrane. The rest of the space between the plates was gasketed by Teflon sheets. The electrolytes were fed into the cell through PFA tubing, at a rate of 60 mL/min controlled by Cole-Parmer Micropump gear pumps.

Before and during the test, the electrolytes were purged with UHP nitrogen to remove and then keep out atmospheric oxygen. Open-circuit potential measurements in FIG. 8a showed battery voltage above 1 V at 50% state of charge. Polarization curves in FIG. 8b showed a peak power density above 0.4 W cm⁻² during room temperature operation.

### EXAMPLE 3

Synthesis of a mixture of the isomeric structures alloxazine 7-carboxylic acid and alloxazine 8-carboxylic acid was carried out following the literature (Liden, A. A. et al. The Journal of Organic

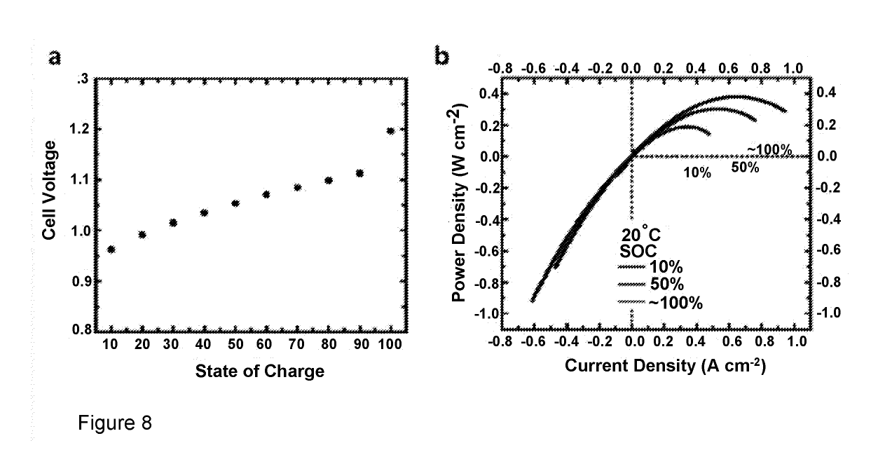

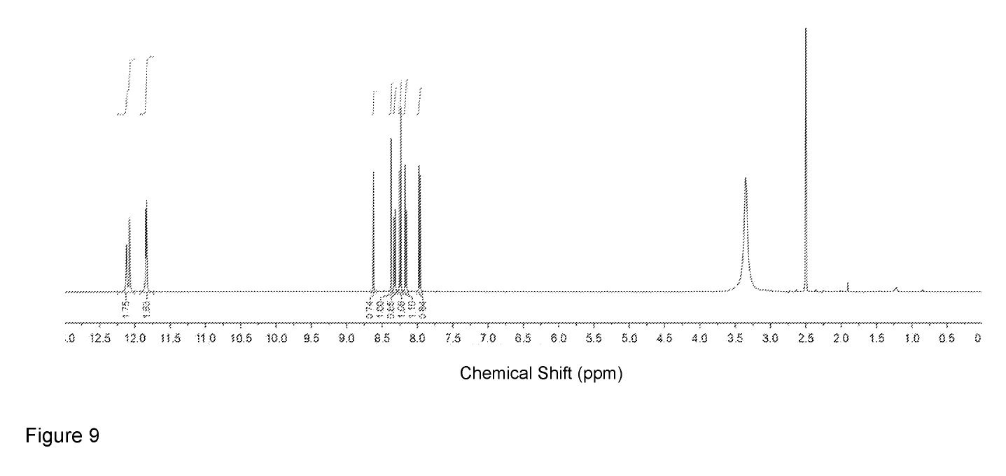

Chemistry 71, 3849-3853 (2006)). 3,4-diaminobenzoic acid (5 g; purchased from VWR) was added to 250 mL acetic acid with gentle stirring. Boric acid (2.5 g; purchased from Sigma Aldrich) and alloxane monohydrate (5.25 g; purchased from VWR) were added to the solution. The reaction mixture was allowed to react under inert atmosphere for 3 hours. The greenish yellow product was vacuum filtered, washed with acetic acid, followed by water and finally by diethyl ether, and dried under vacuum. The ¹H NMR spectrum shown in FIG. 9 matched literature value. This mixture of the isomeric structures alloxazine 7-carboxylic acid and alloxazine 8-carboxylic acid was used for subsequent battery tests without further purification.

### EXAMPLE 4

The positive electrolyte was prepared by dissolving potassium ferrocyanide trihydrate (1.9 g) and potassium ferricyanide (0.15 g) in 1 M KOH solution (11.25 mL) to afford a 0.4 M ferrocyanide +40 mM ferricyanide electrolyte solution. The negative electrolyte was prepared by dissolving the mixture of the isomeric structures alloxazine 7-carboxylic acid and alloxazine 8-carboxylic acid from Example 3 (0.4 g) in 2 M KOH solution (3 mL) resulting a 0.5 M electrolyte solution. Negative electrolyte was prepared at a fully oxidized state. The positive electrolyte contained 9% oxidized species.

Hardware from Fuel Cell Tech. (NM, Albuquerque) was used to assemble a zero-gap flow cell configuration, similar to previous reports (Aaron, D. S. et al. Journal of Power Sources 206, 450-453 (2012)), and shown schematically in FIG. 4. Serpentine flow pattern flow plates were used for both sides. A 5 cm² geometric surface area electrode comprised a stack of three pieces of SGL Sigracet GDL 10AA porous carbon, and a piece of Nafion 212 membrane served as the ion-selective membrane. The rest of the space between the plates was gasketed by Kalrez sheets. The electrolytes were fed into the cell through PFA tubing, at a rate of 60 mL/min controlled by Cole-Parmer Micropump peristaltic pumps.

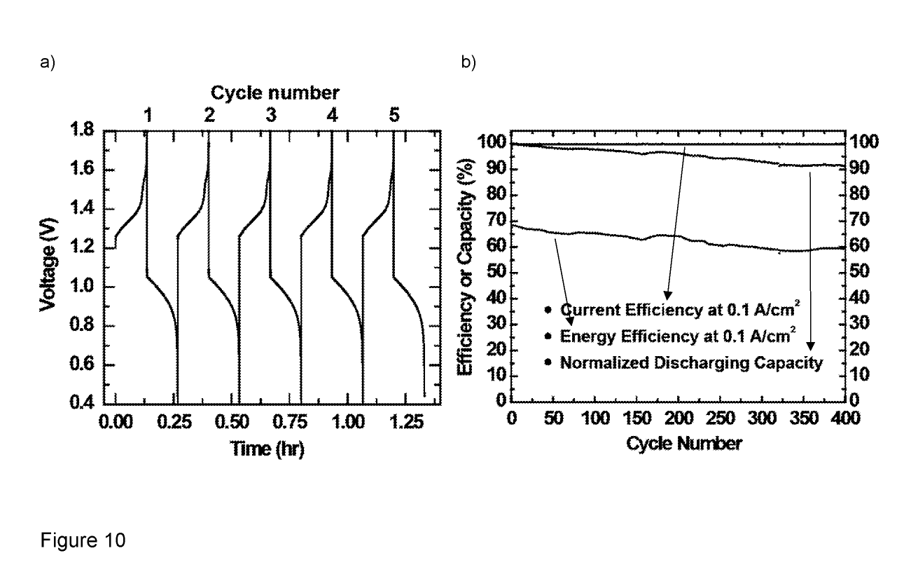

Before and during the test, the electrolytes were purged with UHP nitrogen to ensure deaeration. Galvanostatic cycling shown in FIGS. 10a and 10b was done at 0.1 A/cm², between 0.5 and 1.75 V, controlled by a Gamry 30K Booster potentiostat. The results show an increased cell voltage, compared to the results of Example 2.

### EXAMPLE 5

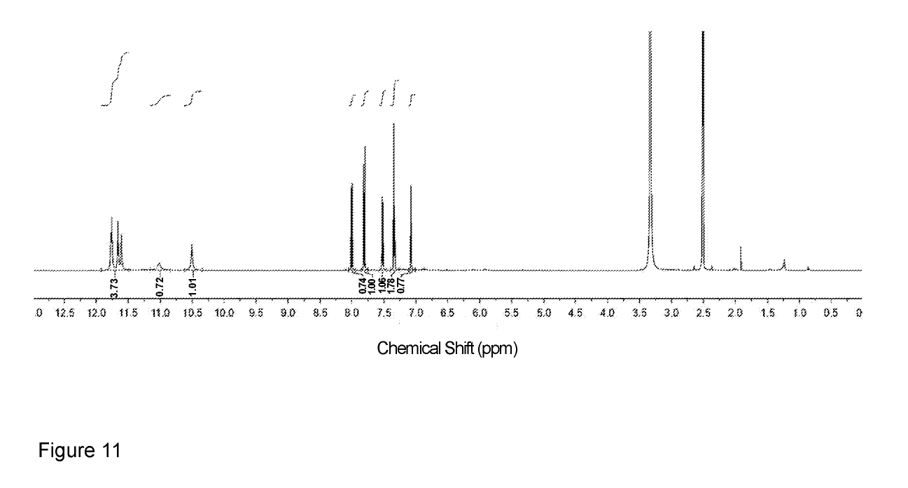

A mixture of the isomers 7-hydroxyalloxazine and 8-hydroxyalloxazine was synthesized by coupling o-phenylenediamine and alloxane in one step at room temperature. 3,4-diaminophenol (1 g; purchased from Aurum Pharmatech) was added to 50 mL acetic acid with gentle stirring. Boric acid (0.6 g; purchased from Sigma Aldrich) and alloxane monohydrate (1.3 g; purchased from VWR) were added to the solution. The reaction mixture was allowed to react under an inert argon atmosphere for 3 hours. The dark green product was vacuum filtered, washed with acetic acid, followed by water and finally by diethyl ether, and dried under vacuum. The yield was higher than 95%. The ¹H NMR spectrum was shown in FIG. 11.

### EXAMPLE 6

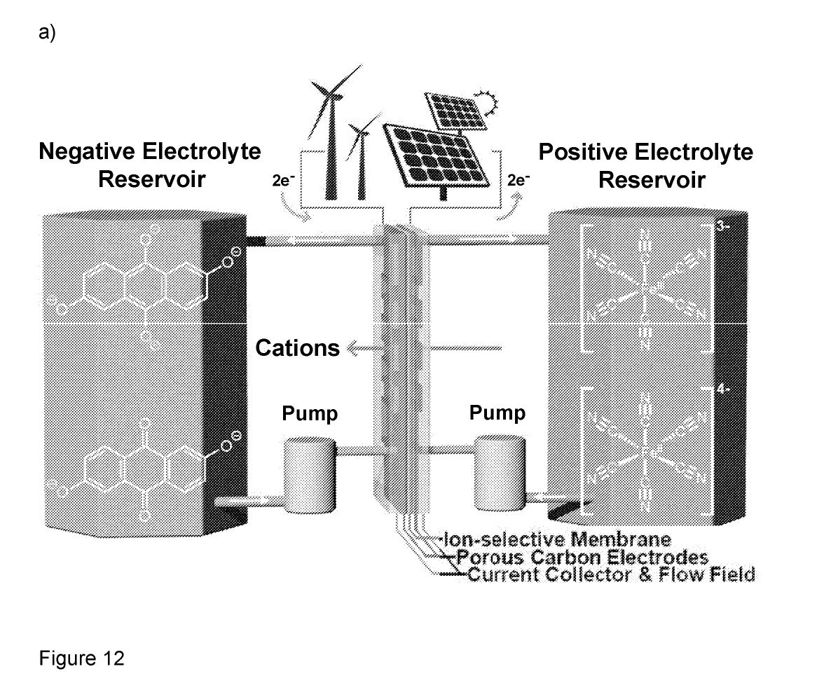

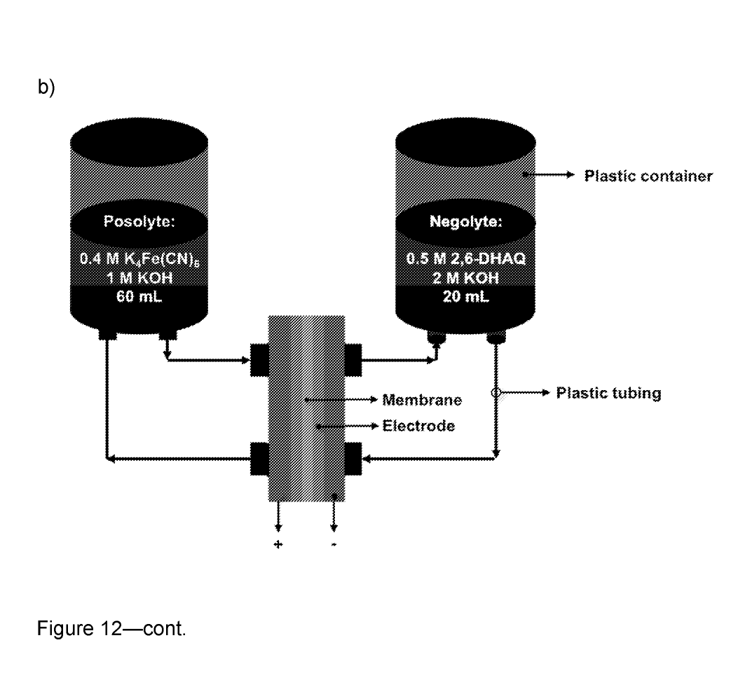

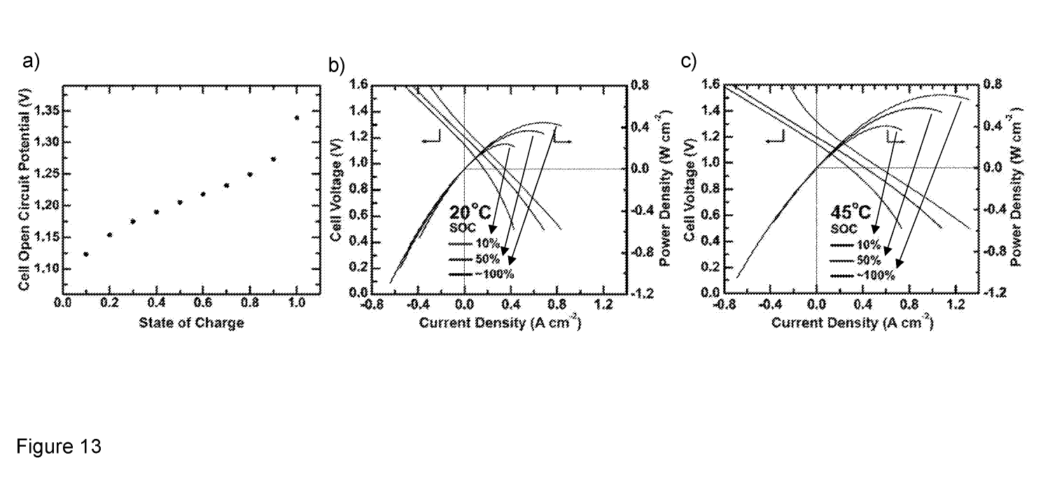

Cell testing was performed at 20° C. using solutions of 0.5 M 2,6-DHAQ in 2 M KOH, and 0.4 M K4Fe(CN)6 in 1 M KOH. These solutions were pumped through a flow cell constructed from graphite flow plates and carbon paper electrodes, which were separated by a Nafion membrane (FIGS. 12a and 12 b). A charging current of 0.1 A cm⁻² was applied to charge the cell, and polarization curves were measured at 10%, 50%, and 100% states of charge (SOC). The open-circuit voltage (OCV) vs. state of quinone charge (SOC) is shown in FIG. 13a. The polarization curves (FIG. 13b) show peak galvanic power densities beyond 0.45 W cm⁻².

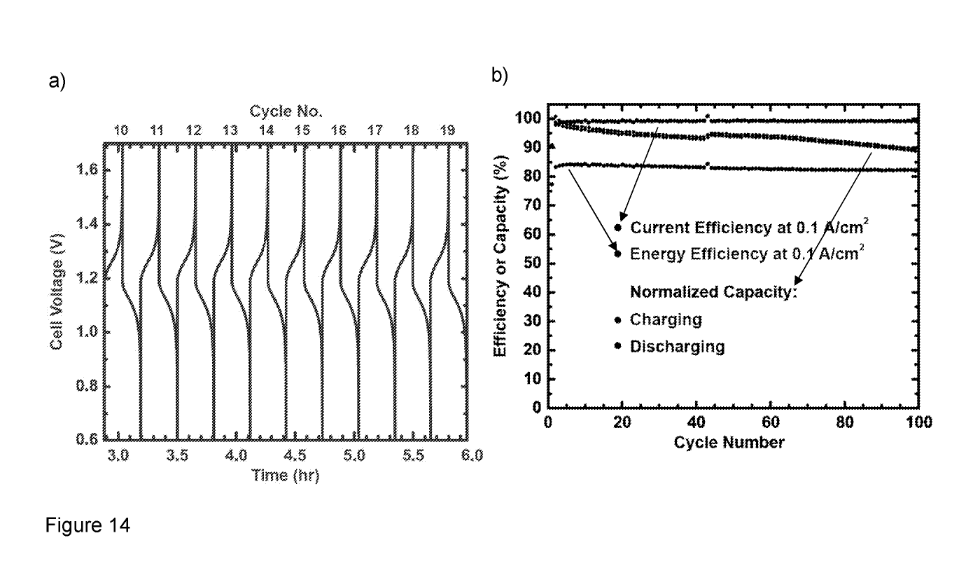

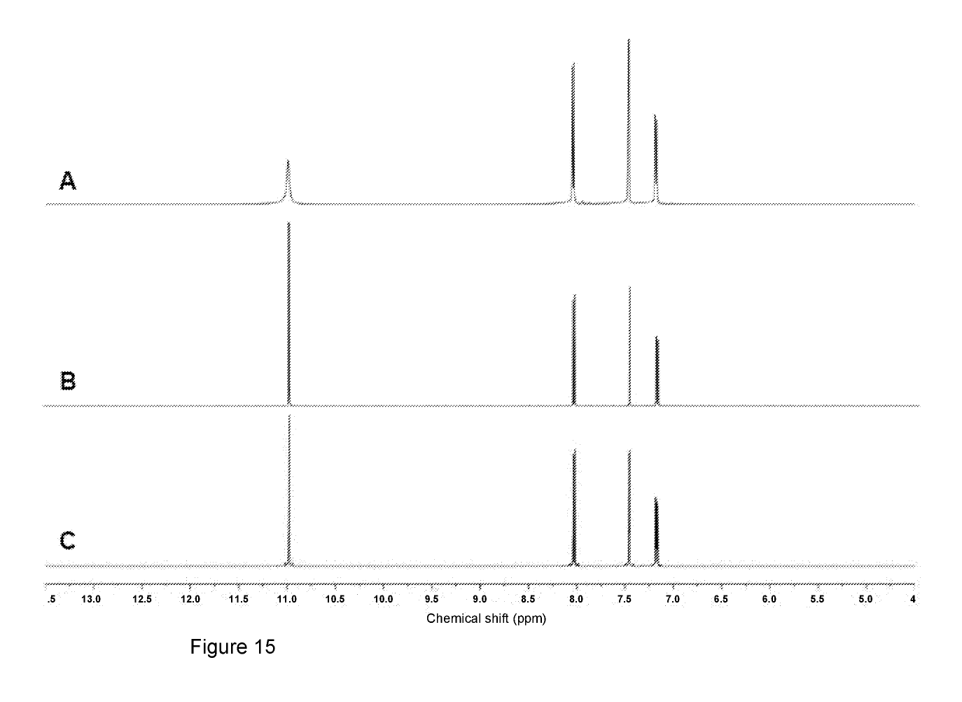

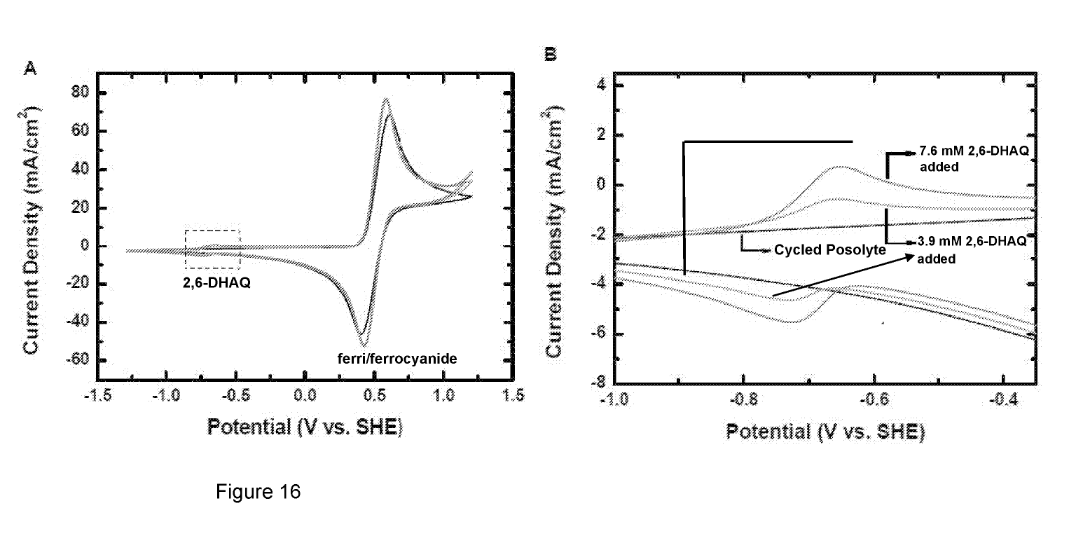

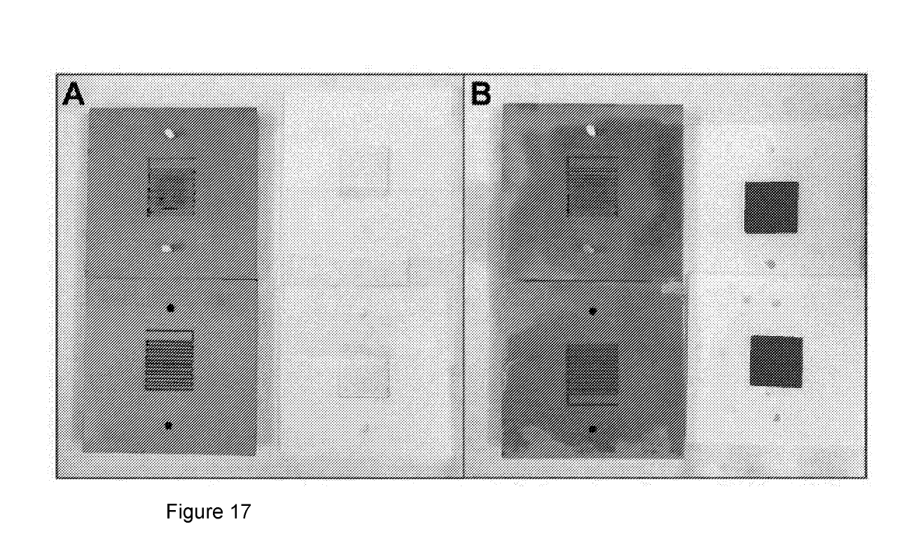

The cell was cycled at a constant current density of ±0.1 A cm⁻² for 100 cycles (FIG. 14a). The cell exhibited a current efficiency exceeding 99%, with a round-trip energy efficiency of roughly 84%. A 0.1% loss in capacity per cycle was observed during cycling, which appears to be a continuous loss of electro-active species over the 100 cycles (FIG. 14b). We explored three possible loss mechanisms: chemical decomposition, electrolyte crossover through the membrane, and leakage from the pumping system. Analysis of the DHAQ electrolyte solution by proton NMR showed no decomposition product at the sensitivity level of 1% (FIGS. 15a-c). Cyclic voltammetry of the ferrocyanide electrolyte showed that <1% of the 2,6-DHAQ migrated across the membrane. This observation places an upper limit on crossover of 0.8% of the DHAQ, implying a crossover current density of <2.5 μA cm⁻² (FIGS. 16a and 16b). We carefully collected the negolyte (negative electrolyte) solution, dried and weighed; we found that roughly 92% of 2,6-DHAQ can be recovered, suggesting leakage in the pumping system as the origin of capacity loss. A source of leakage was readily apparent but not quantifiable at the exit of the humidified nitrogen bubbling through the negolyte to prevent energy loss by permeation of atmospheric oxygen. Coloration could also be found on the gaskets, indicating a likely site of electrolyte leakage (FIGS. 17a and 17b). We expect that the capacity loss can be substantially reduced by improvements to the mechanical containment in our small-scale (10 mL) system.

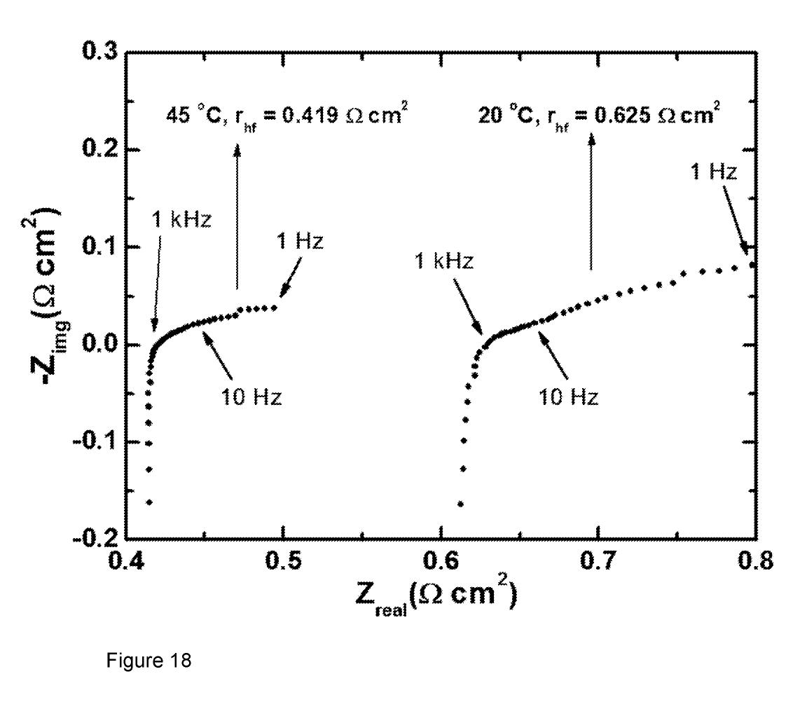

By increasing the temperature to 45° C., the peak galvanic power density increases from 0.45 W cm⁻² to approximately 0.7 W cm⁻² (FIG. 13c), as the cell area-specific resistance (ASR) decreases from about 0.878 to 0.560 0 cm², estimated from the linear parts of the polarization curves in FIG. 13. The majority of this ASR decrease comes from a change in the high frequency area-specific resistance (rhf) measured by electrochemical impedance spectroscopy (FIG. 18). In both cases, the rhf contributes more than 70% of the ASR and is indeed the limiting factor to the cell current and power outputs. The rhf is dominated by the resistance of the membrane, which is an order of magnitude higher than the resistance of the same membrane in a pH 0 acid solution.

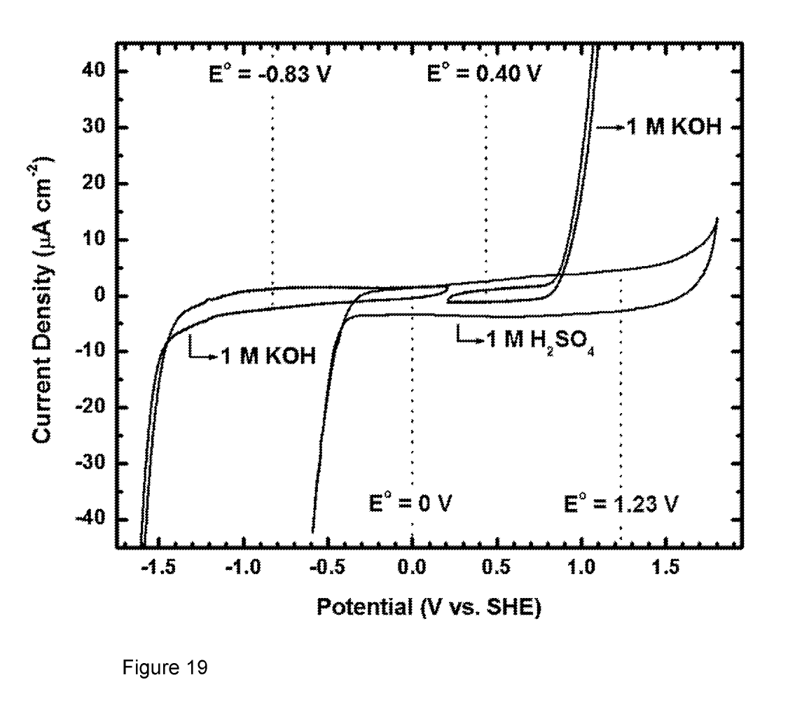

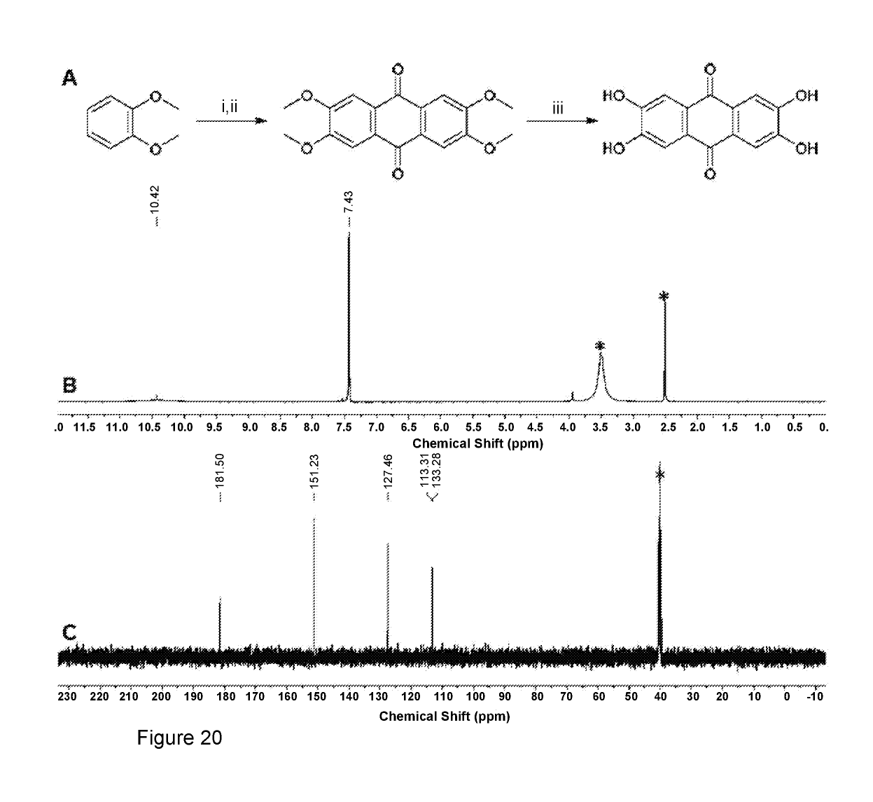

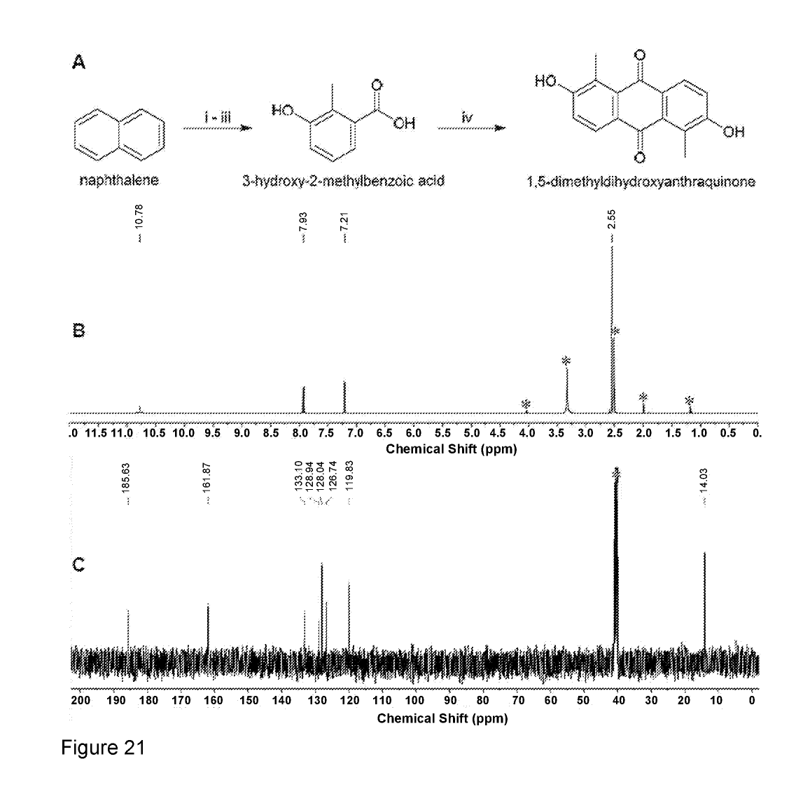

The sluggish kinetics of the hydrogen evolution reaction in alkaline solution on carbon electrodes results in a larger practical stability window in base rather than in acid (FIG. 19). Consequently, quinones with substantially more negative reduction potentials are feasible as negative electrolyte materials. Preliminary investigations into the synthesis of different hydroxyl-substituted anthraquinones suggest that further increases in cell potential are possible. Self-condensation reactions of substituted benzene yield 2,3,6,7-tetrahydroxy-AQ (THAQ) and 1,5-dimethyl-2,6-DHAQ (15-DMAQ) (FIGS. 20a-20c and 21a-21c). The cyclic voltammograms of these species in 1 M KOH suggest cell potentials versus ferricyanide/ferrocyanide approaching 1.35 V (FIGS. 2b and 2c), which exceeds that of many aqueous rechargeable batteries (FIG. 2d).

### EXAMPLE 7

2,6-dihydroxy-1,5-dimethyl-9,10-anthraquinone was prepared using the following reactions:

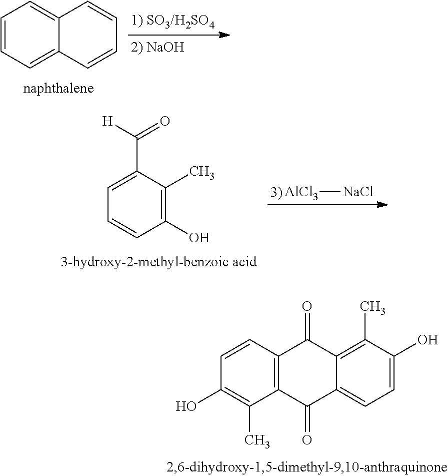

The starting material, naphthalene, was first heated with fuming sulfuric acid (also known as oleum), and then treated with a strong base, such as sodium hydroxide. Detailed reaction conditions for carrying out these steps 1) and 2) have been published in US Patent Publication 2005/0222455, along with methods for purifying the intermediate product, 3-hydroxy-2-methyl-benzoic acid.

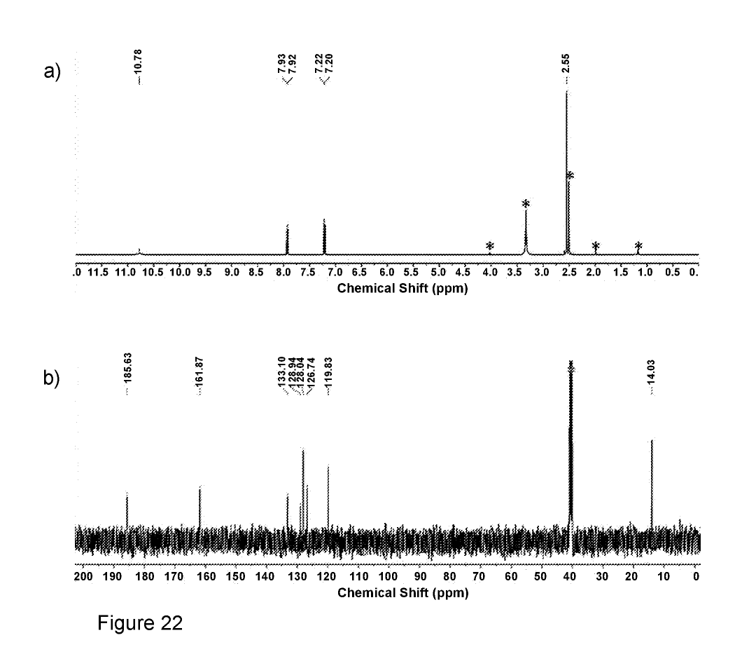

Conversion of this intermediate to the desired product, 1,5-dimethyl-2,6-dihydroxy-9,10-anthraquinone, was accomplished by heating the 3-hydroxy-2-methyl-benzoic acid in the presence of aluminum chloride and sodium chloride to a temperature of around 200° C. for 2 hours. NMR spectra in FIG. 22 confirm the production of 1,5-dimethyl-2,6-dihydroxy-9,10-anthraquinone. FIG. 22(a) ¹HNMR (500 MHz, DMSO-d6) spectra of 2,6-dihydroxy-1,5-dimethyl-anthraquinone 6: 10.78 (br, 2H, 2 x Ar-OH), 7.92 (d, 2H, J═8.5 Hz, 2 x ArCH), 7.21 (d, 2H, J═8.5 Hz, 2 x ArCH), 2.55 (s, 6H, 2 x Ar-CH₃). FIG. 22(b) ¹³CNMR (125 MHz, DMSO-d6) 6 185.63, 161.87, 133.10, 128.94, 128.04, 126.74, 119.83, 14.03. Solvent peaks are labeled by asterisks.

### EXAMPLE 8

Example 6 was repeated with a negative electrolyte prepared by dissolving 2,6-dihydroxy-1,5-dimethyl-9,10-anthraquinone (1.2 g) made as in Example 7 in 2 M KOH solution (10 mL). Tests similar to Example 6 were carried out, showing that the open circuit voltage at 50% state of charge is 1.34 volts with this compound as the negative electrolyte in a flow battery.

### Methods for Examples 6-8

Solubility measurement. Room temperature solubility in 1 M KOH solution was measured by measuring the absorbance at 413 nm and comparing to an absorbance-vs.-concentration calibration curve determined by preparing known concentrations of 2,6-DHAQ. UV-Vis spectrophotometry measurements were performed using an Agilent Cary 60 spectrophotometer equipped with a Quantum

Northwest T2 temperature regulator. Appropriate aliquots of 2,6-DHAQ stock solution were added to 1 M KOH blank solution and their UV-Vis absorbance spectra measured. A saturated solution of 2,6-DHAQ in 1 M KOH was prepared by adding 2,6-DHAQ potassium salt into 1 M KOH solution (10 mL) until a thin layer of precipitate formed, the remaining solution was diluted by known proportions, and the absorbance of the resulting solution was compared to the calibration curve.

Electrochemical characterization. A glassy carbon electrode was used for three-electrode cyclic voltammetry tests, except in the electrochemical window tests where graphite foil was used to mimic the condition of porous carbon paper. Rotating-disk electrode (RDE) experiments of 2,6-DHAQ (1 mM) in 1 M KOH solution were performed using a BASi RDE-2 rotating-disk electrode system (FIG. 3a). All tests were carried out using a Gamry Reference 3000 potentiostat, with a Pt counter electrode and an Ag/AgCI reference electrode (equilibrated with 3M NaCI, 213 mV vs. standard hydrogen electrode. A Levich plot was constructed from the RDE data by plotting the mass-transport limited current vs. the square root of the rotation rate (FIG. 3b). The diffusion coefficient of 2,6-DHAQ was calculated for each of three runs from the slope of the line fit to the Levich equation (Bard, A. J. & Faulkner, L. R. Electrochemical Methods: Fundamentals and Applications. (Wiley, 2000)). The kinematic viscosity was taken to be 1.08×10⁻⁶ m² s⁻¹ (Hitchcock, L. B. & Mcllhenny, J. S. Ind. Eng. Chem. 27, 461-466 (1935)). The resulting value of the diffusion coefficient is 4.8(2) x 10⁻⁶ cm² s⁻¹.

Cyclic voltammogram modeling. Computation was performed using Mathematica 10.0.1.0 according to algorithms by Oldham and Myland (Oldham, K. B. & Myland, J. C. Electrochim. Acta 56, 10612-10625 (2011)). The diffusivity of 2,6-DHAQ and both the one-electron and two-electron reduction products were assumed to be 4.8 x 10⁻⁶ cm² s⁻¹, based on our RDE studies. The temperature was 293 K. Time was discretized into 40 ms increments, and the current at each time was computed based on the sum of previous currents as described by Oldham (Oldham, K. B. & Myland, J. C. Electrochim. Acta 56, 10612-10625 (2011)).

To model the two-electron reduction process (FIG. 1), the Butler-Volmer equation with the number of electrons n ═2 was used in place of Oldham equation (4:5), and the right-hand-side of equation (8:3) was multiplied by 2 to account for a two-electron reduction (Bard, A. J. & Faulkner, L. R. Electrochemical Methods: Fundamentals and Applications. (Wiley, 2000); Oldham, K. B. & Myland, J. C. Electrochim. Acta 56, 10612-10625 (2011)). The reduction potential was assumed to be equal to the voltage equidistant from the two peaks on the measured cyclic voltammogram (-0.684 V vs. SHE) and the charge transfer coefficient a was assumed to be 0.5. The electrochemical rate constant ko was then varied from 10⁻³ cm s⁻¹ to 10⁻⁵ cm s⁻¹.

To model the two successive one-electron reductions (FIG. 3d), Oldham equations (12:13) and (12:14) were used (Oldham, K. B. & Myland, J. C. Electrochim. Acta 56, 10612-10625 (2011)). The charge transfer coefficients al and a2 were assumed to be equal to 0.5, and the electrochemical rate constants for the two reductions were assumed equal. The values of the single rate constant and the first and second reduction potentials were permitted to vary freely. A reasonable fit to the experimental data was observed when the reduction potential of the first reduction Ei ═-0.657 V vs. SHE, the reduction potential of the second reduction E2 ═-0.717 V vs. SHE, and the two electrochemical rate constants ko,i and ko,2 both equaled 7×10⁻³ cm s⁻¹, a value very close to that observed in other anthraquinone systems (Huskinson, B. et al. Nature 505, 195-198 (2014)).

Full cell measurement. a) 20° C. cell performance and cycling study. The positive electrolyte was prepared by dissolving potassium ferrocyanide trihydrate (5.12 g) in 1 M KOH solution (30 mL) to afford a 0.4 M ferrocyanide and 2.6 M potassium electrolyte solution. The negative electrolyte was prepared by dissolving 2,6-DHAQ (1.2 g) in 2 M KOH solution (10 mL) resulting a 0.5 M 2,6-DHAQ and 1 M potassium electrolyte solution. b) 40° C. cell performance study. The positive electrolyte was prepared by dissolving potassium ferrocyanide trihydrate (10.2 g) in 1 M KOH solution (30 mL) to afford a 0.8 M ferrocyanide and 4.6 M potassium electrolyte solution. The negative electrolyte was prepared by dissolving 2,6-DHAQ (2.4 g) in 3 M KOH solution (10 mL) resulting a 1 M 2,6-DHAQ and 3 M potassium electrolyte solution. For all full cell studies, both electrolytes were assembled in the fully discharged state.

Cell hardware from Fuel Cell Tech. (Albuquerque, NM) was used to assemble a zero-gap flow cell configuration, similar to previous reports (Liu, Q. H. et al. J. Electrochem. Soc. 159, A1246-A1252 (2012)). Serpertine flow pattern flow plates were used for both sides. A 5 cm² geometric surface area electrode comprised a stack of three pieces of Sigracet SGL 10AA porous carbon paper. A piece of Nafion 212 membrane soaked in DI water prior to tests served as the ion-selective membrane. The rest of the space between the plates was gasketed by Teflon sheets. The electrolytes were fed into the cell through PFA tubing, at a rate of 60 mL/min controlled by MasterFlex diaphragm pumps.

Before and during the tests, the electrolytes were purged with UHP nitrogen to ensure deaeration. Galvanostatic cycling was performed at ±0.1 A/cm², with voltage limits of 0.6 and 1.7 V, controlled by a Gamry 30K Booster potentiostat. To obtain the polarization curves, the cell was first charged to the desired SOC, and then polarized via linear sweep voltammetry at a rate of 100 mV/s. This method was found to yield polarization curves very close to point-by-point galvanostatic holds, yet to impose minimal perturbation to the SOC of the small-electrolyte-volume cell. EIS was performed at 50% SOC, open-circuit potential, and 2 mA/cm² AC current density, with frequency ranging from 1 to 100,000 Hz.

Gravimetric study. 2,6-DHAQ negolyte solution after 20° C. cell cycling studies was collected by pumping the solution into a clean flask; the system was then washed with KOH solution until the eluent showed no color. The collected solution was then dried under vacuum and acidified using a 2 M HCI solution. The yellow precipitate was then filtered by a pre-weighed Buchner funnel and air dried overnight. The weight of the precipitate was measured by difference.

Crossover study. The concentration of crossed-over 2,6-DHAQ into the ferro-ferricyanide posolyte solution was evaluated using CV. After 100 charge-discharge cycles, the ferro-ferricyanide posolyte solution (5 mL) was collected and analyzed by CV (scan at 100 mV/s. The correlation between the CV signal and 2,6-DHAQ concentration was established by titrating known amounts of 2,6-DHAQ (12 mg or 20 mM) to the cycled posolyte followed by controlled dilution. The comparison indicates <10 mM 2,6-DHAQ had crossed over into the posolyte, which corresponds to <2% of the 2,6-DHAQ originally assembled into the negolyte.

Chemical preparation. All chemicals were purchased from Sigma Aldrich and used as received unless stated otherwise. 2,6-DHAQ, purchased from AK Scientific Inc., was recrystallized from DMF-water mixture to afford bright yellow crystals. This purified compound was used for all electrochemical measurements. 2,3,6,7-tetrahydroxyanthraquinone was prepared using a previously reported synthetic route (Balaban, T. S. et al. Hely. Chim. Acta 89, 333-351 (2006).). The overall yield was 29.4%.

Other embodiments are described in the claims.

What is claimed is:

1. A redox flow battery comprising:
a first aqueous electrolyte comprising a first type of redox active material; and
a second aqueous electrolyte comprising a second type of redox active material,
wherein the first type of redox active material is a quinone or an alloxazine, wherein during charge the quinone is reduced to a hydroquinone or the alloxazine is reduced to a hydroalloxazine, and wherein, when the first type of redox active material is the quinone, the pH of the first aqueous electrolyte is greater than 7.

2. The battery of claim 1, wherein the first type of redox active material is an alloxazine.

3. The battery of claim 1, wherein first type of redox active material is a quinone.

4. The battery of claim 1, wherein the first type of redox active material comprises a compound of formula (I): 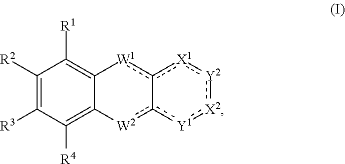
wherein
i) W¹ and W² are -C═O, and Y¹ is -C(R⁵)-, X² is -C(R⁶)-, Y² is -C(R⁷)-, and X¹ is -C(R⁸)-;
ii) X¹ and X² are -C═O, W¹ and W² are -N-, Y¹ is -N(R⁹)-, and Y² is -N(R¹⁰)-; or
iii) X¹ and X² are -C═O, W² is -N(R⁹)-, Y² is -N(R¹⁰)-, and W¹ and Y¹ are -N-,
wherein bonds shown with dashed lines are single or double bonds, and
wherein each of R⁹ and R¹⁰, if present, is independently H; optionally substituted C₁₋₆ alkyl;
optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; -C(═O)Rₐ; and -C(═O)ORₐ; and
each of R¹, R², R³, R⁴, R⁵, R⁶, R⁷ and R⁸, if present, is independently H; halo; optionally substituted C₁₋₆ alkyl; oxo; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; -NO₂; -ORₐ; -N(Rₐ)₂; -C(═O)Rₐ; -C(═O)ORₐ; -S(═O)₂Rₐ; -S(═O)₂ORₐ; -P(═O)R_{a 2}; and -P(═O)(ORₐ)₂; or any two adjacent groups selected from R¹, R², R³, and R⁴ are joined to form an optionally substituted 3-6 membered ring, or an ion thereof;
wherein each Rₐ is independently H; C₁₋₆ alkyl; optionally substituted C₃₋₁₀ carbocyclyl;
optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group,
or an isomer, ion, or polymer thereof.

5. The battery of claim 4, wherein the compound of formula (I) is an alloxazine of formula (III): 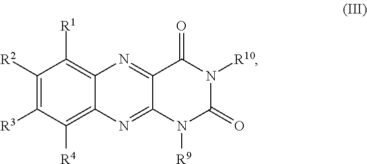
wherein each of R⁹ and R¹⁰ is independently H; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; -O(═O)Rₐ; and -C(═O)ORₐ; and
each of R¹, R², R³, and R⁴ is independently H; C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; -NO₂; -ORₐ; -N(Rₐ)₂; -C(═O)Rₐ; -C(═O)ORₐ; -S(═O)₂Rₐ; -S(═O)₂ORₐ; -P(═O)Rₐ₂; and -P(═O)(ORₐ)₂; or any two adjacent groups selected from R¹, R², R³, and R⁴ are joined to form an optionally substituted 3-6 membered ring, or an ion thereof;
wherein each Rₐ is independently H; C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group.

6. The battery of claim 4, wherein the compound of formula (I) is an isoalloxazine of formula (IV): 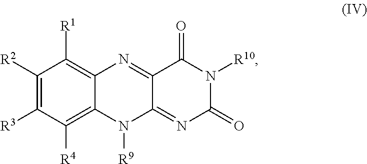
wherein each of R⁹ and R¹⁰ is independently H; optionally substituted C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; -O(═O)Rₐ; and -C(═O)ORₐ; and
each of R¹, R², R³, and R⁴ is independently H; C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; -NO₂; -ORₐ; -N(Rₐ)₂; -C(═O)Rₐ; -C(═O)ORₐ; -S(═O)₂Rₐ; -S(═O)₂ORₐ; -P(═O)Rₐ₂; and -P(═O)(ORₐ)₂; or any two adjacent groups selected from R¹, R², R³, and R⁴ are joined to form an optionally substituted 3-6 membered ring, or an ion thereof;
wherein each Rₐ is independently H; C₁₋₆ alkyl; optionally substituted C₃₋₁₀ carbocyclyl; optionally substituted C₁₋₉ heterocyclyl having one to four heteroatoms independently selected from O, N, and S; optionally substituted C₆₋₂₀ aryl; optionally substituted C₁₋₉ heteroaryl having one to four heteroatoms independently selected from O, N, and S; an oxygen protecting group; or a nitrogen protecting group.

7. The battery of claim 5 or 6, wherein:
each of R⁹ and R¹⁰ is independently H, optionally substituted C₁₋₆ alkyl, or -O(═O)ORₐ; and
each of R¹, R², R³, and R⁴ is independently H, halo, optionally substituted C₁₋₆ alkyl, -NO2, -ORₐ, -N(Rₐ)₂, -C(═O)ORₐ, -S(═O)₂ORₐ, -P(═O)Rₐ₂ or -P(═O)(ORₐ)₂;
wherein each Rₐ is independently H or optionally substituted C₁₋₆ alkyl.

8. The battery of claim 5 or 6, wherein none of, any two of, any three of, any four of, any five of, or any six of R¹, R², R³, R⁴, R⁹, and R¹⁰ are H.

9. The battery of claim 4, wherein the compound is riboflavin 5′ phosphate, having the formula

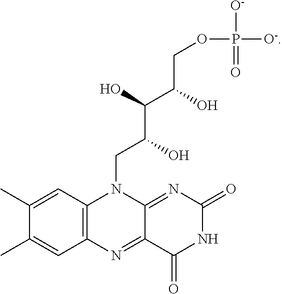

10. The battery of claim 4, wherein the compound is an alloxazine comprising a mixture of the isomeric structures alloxazine 7-carboxylic acid and alloxazine 8-carboxylic acid:

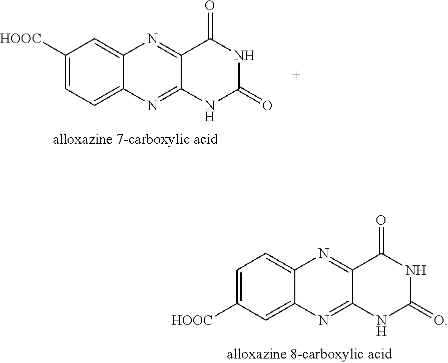 [SMILES: O=C(O)c1ccc2nc3[nH]c(=O)[nH]c(=O)c3nc2c1 ; O=C(O)c1ccc2nc3c(=O)[nH]c(=O)[nH]c3nc2c1]

11. The battery of claim 4, wherein the compound is an alloxazine comprising a mixture of the isomeric structures 7-hydroxyalloxazine and 8-hydroxyalloxazine:

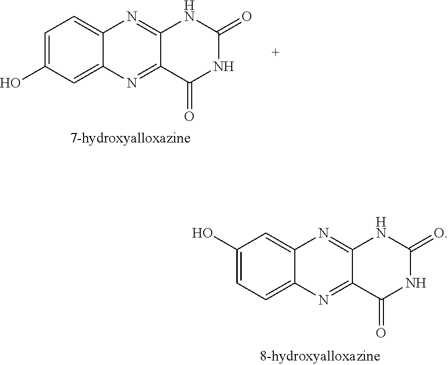 [SMILES: O=c1[nH]c(=O)c2nc3cc(O)ccc3nc2[nH]1 ; O=c1[nH]c(=O)c2nc3ccc(O)cc3nc2[nH]1]

12. The battery of claim 4, wherein the compound of formula (I) is 7,8-dihydroxyalloxazine:

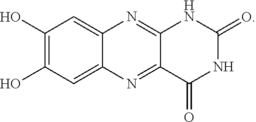 [SMILES: O=c1[nH]c(=O)c2nc3cc(O)c(O)cc3nc2[nH]1]

13. The battery of claim 4, wherein the compound is an alloxazine polymer according to: 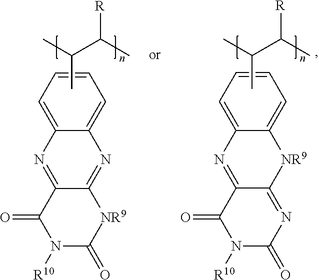
wherein n is an integer from 2 to 40 and R is a substituent that increases the water solubility of the polymer.

14. The battery of claim 13, in which the polymer is a dimer.

15. The battery of claim 13, in which the polymer is a trimer.

16. The battery of claim 4, wherein the compound is a quinone of the formula (II): 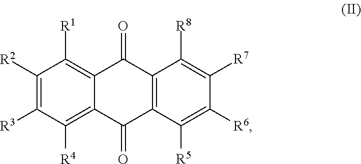
wherein each of R1, R2_{,} R3, R⁴, R5, ^{R6,} R⁷ and R⁸ is independently selected from H, optionally substituted C₁₋₆ alkyl, halo, hydroxyl, optionally substituted C₁₋₆ alkoxy, SO₃H, amino, nitro, carboxyl, phosphoryl, phosphonyl, and oxo, or an ion thereof.

17. The battery of claim 16, wherein each of R¹, R², R³, R⁴, R⁵, R⁶, R⁷ and R⁸ is independently selected from H, hydroxyl, optionally substituted C₁₋₄ alkyl, carboxyl, and SO₃H.

18. The battery of claim 16, wherein each of R¹, R², R³, R⁴, R⁵, R⁶, R⁷ and R⁸ is independently selected from H, hydroxyl, optionally substituted C₁₋₄ alkyl, and oxo.

19. The battery of any one of claims 16, wherein the quinone is substituted with at least one hydroxyl group.

20. The battery of claim 19, wherein the quinone is further substituted with at least one methyl group.

21. The battery of claim 16, wherein the quinone is of the formula:
TABLE 1

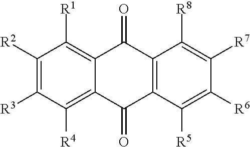

| R substituted | R₁ | R₂ | R₃ | R₄ | R₅ | R₆ | R₇ | R₈ |
|---|---|---|---|---|---|---|---|---|
| | H | OH | H | H | H | H | H | H |
| | H | SO₃H | H | H | H | H | H | H |
| Di- | OH | OH | H | H | H | H | H | H |
| | OH | H | OH | H | H | H | H | H |
| | OH | H | H | OH | H | H | H | H |
| | OH | H | H | H | OH | H | H | H |
| | OH | H | H | H | H | H | OH | H |
| | OH | H | H | H | H | H | H | OH |
| | H | OH | H | H | H | OH | H | H |
| | H | OH | H | H | H | H | OH | H |
| | H | SO₃H | H | H | H | H | SO₃H | H |
| Tri- | OH | OH | OH | H | H | H | H | H |
| | OH | OH | H | OH | H | H | H | H |
| | OH | OH | H | H | H | OH | H | H |
| | OH | OH | H | H | H | H | OH | H |
| | OH | H | OH | H | H | H | H | OH |
| | OH | OH | SO₃H | H | H | H | H | H |
| | OH | SO₃H | H | OH | H | H | H | H |
| Tetra- | OH | OH | OH | OH | H | H | H | H |
| | OH | OH | H | H | OH | OH | H | H |
| | OH | OH | H | H | OH | H | H | OH |
| | OH | H | H | OH | OH | H | H | OH |
| | H | OH | OH | H | H | OH | OH | H |
| | OH | SO₃H | OH | OH | H | H | H | H |
| | OH | SO₃H | H | OH | H | SO₃H | H | H |
| | OH | SO₃H | H | OH | H | H | SO₃H | H |
| | OH | SO₃H | H | H | H | H | OH | SO₃H |
| Penta- | OH | SO₃H | OH | OH | H | SO₃H | H | H |
| | OH | SO₃H | OH | OH | H | H | SO₃H | H |

or an ion thereof.

22. The battery of claim 16, wherein the quinone is 2,6-dihydroxy-9,10-anthraquinone, 1,5-dimethyl-2,6-di hydroxy-9 ,10-anthraquin one, 2,3,6,7-tetrahydroxy-9,10-anthraquinone, 1 ,3,5,7-tetrahydroxy-2,4,6,8-tetramethyl-9,10-anthraquinone, or 2,7-dihydrox-1,8-dimethyl-9,10-anthraquinone.

23. The battery of any one of claims 1-22, wherein the second type of redox active material comprises a hexacyanoiron complex, aluminum(III) biscitrate monocatecholate, bromine or bromide, or iodine or iodide.

24. The battery of claim 23, wherein the second type of redox active material comprises ferricyanide ion, ferrocyanide ion, or a mixture thereof.

25. The battery of claim 23, wherein the second type of redox active material comprises aluminum(III) biscitrate monocatecholate.

26. The battery of claim 23, wherein the second type of redox active material comprises bromine or bromide.

27. The battery of claim 23, wherein the second type of redox active material comprises iodine or iodide.

28. The battery of any one of claims 1-27, further comprising a first electrode in contact with the first aqueous electrolyte and a second electrode in contact with the second aqueous electrolyte.

29. The battery of any one of claims 1-28, further comprising a separator between the first aqueous electrolyte and the second aqueous electrolyte.

30. The battery of claim 29, wherein the separator is an ion conducting barrier.

31. The battery of claim 29, wherein the barrier is a porous physical barrier or a size exclusion barrier.

32. The battery of claim 29, wherein the separator comprises a porous material, a cation exchange membrane, or an ion-conducting glass.

33. The battery of any one of claims 1-32, further comprising reservoirs for the first aqueous electrolyte and second aqueous electrolyte and a mechanism to circulate the electrolytes.

34. The battery of any one of claims 1-33, wherein the first aqueous electrolyte has a pH between about 7 and about 10, or between about 10 and about 12, or between about 12 and about 14.

35. The battery of any one of claims 1-34, wherein the first type of redox active material is present in the first aqueous electrolyte in a concentration of at least about 0.5 M, at least about 1 M, or at least about 2 M.

36. The battery of any one of claims 1-35, wherein the first type of redox active material is present in the first aqueous electrolyte in a concentration of between about 0.5 and about 2 M, or between about 2 M and about 4 M.

37. A method for storing electrical energy comprising applying a voltage across a first electrode in contact with the first aqueous electrolyte and a second electrode in contact with the second aqueous electrolyte and charging a battery of any one of claims 1-36.

38. A method for providing electrical energy by connecting a load to a first electrode in contact with the first aqueous electrolyte and a second electrode in contact with the second aqueous electrolyte and allowing a battery of any one of claims 1-36 to discharge.
